(19) United States
(12) Patent Application Publication
(10) Pub. No.: US 2026/0289943 A1
(43) Pub. Date: Sep. 24, 2026

(54) SYSTEM

(71) Applicant: SoftBank Group Corp., Tokyo (JP)

(72) Inventor: Haruka GOTO, Tokyo (JP)

(73) Assignee: SoftBank Group Corp., Tokyo (JP)

(21) Appl. No.: 19/555,930

(22) Filed: Mar. 4, 2026

(30) Foreign Application Priority Data
Mar. 19, 2025 (JP) 2025-044489

(51) Int. Cl. G06V 10/25; G06N 3/0464; G06N 3/0475; G06V 10/764; G06V 10/77; G06V 30/10; G10L 25/63

(52) U.S. Cl. CPC G06V 10/25; G06N 3/0464; G06N 3/0475; G06V 10/764; G06V 10/7715; G06V 30/10; G10L 25/63; G06V 2201/07

(57) ABSTRACT

A system includes a processor that is configured to receive digital data acquired by a user using an imaging device and perform preprocessing on the digital data, generate a first prompt for instructing a generative AI model to identify product information, manufacturing information, and deterioration information from the preprocessed digital data, and input the first prompt to the generative AI model, and generate a second prompt for instructing the generative AI model to identify products not owned by the user and to propose new products based on an interest of the user, input the second prompt to the generative AI model, and obtain proposals for the new products from the generative AI model.

### CROSS-REFERENCE TO RELATED APPLICATION

This application is based on and claims priority under 35 USC 119 from Japanese Patent Application No. 2025-044489 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recommendation systems typically rely on explicit user input, purchase history, or browsing behavior to infer user preferences and to propose new products. Such systems have difficulty accurately understanding what products a user currently owns, the manufacturing information of those products, or the deterioration state of the owned products, because this information is rarely entered manually by the user and is often not fully available in transaction logs. As a result, conventional systems may propose products that are redundant with existing owned products, may fail to identify opportunities for upgrades where deterioration has progressed, and may not effectively discover and propose products that the user does not own but that would be beneficial in light of the user's actual environment and interests. Furthermore, while generative AI models have recently become capable of producing sophisticated text and recommendations, there is no sufficient mechanism in the prior art for systematically generating prompts that cause a generative AI model to infer product information, manufacturing information, deterioration information, and gaps in ownership from digital data such as images or video acquired by a user. Therefore, there is a need for a system that automatically receives digital data captured by a user, derives detailed product-related information and deterioration information using a generative AI model, identifies products not owned by the user, and generates appropriate proposals for new products in accordance with the user's interests.

### SUMMARY

In order to solve the above-described problems, according to one aspect of the present invention, there is provided a system comprising a processor, wherein the processor is configured to receive digital data acquired by a user using an imaging device and perform preprocessing on the digital data, generate a first prompt for instructing a generative AI model to identify product information, manufacturing information, and deterioration information from the preprocessed digital data, and input the first prompt to the generative AI model. By doing so, the system enables the generative AI model to derive detailed attributes of products appearing in the digital data, including at least one of product specifications, manufacturing dates, and deterioration states, without requiring manual input from the user. Furthermore, the processor is configured to generate a second prompt for instructing the generative AI model to identify products not owned by the user and to propose new products based on an interest of the user, input the second prompt to the generative AI model, and obtain proposals for the new products from the generative AI model. In some embodiments, the processor is further configured to generate a third prompt for instructing the generative AI model to propose new products based on deterioration information of products owned by the user, input the third prompt to the generative AI model, and obtain proposals for the new products from the generative AI model, thereby enabling recommendations that take into account aging and wear of existing products. In other embodiments, the processor is configured to generate a fourth prompt for instructing the generative AI model to identify products not owned by the user and to propose products that are beneficial to use in combination with products owned by the user, input the fourth prompt to the generative AI model, and obtain proposals for the products that are beneficial to use in combination with the products owned by the user from the generative AI model. Through these configurations, the system can automatically understand the user's actual environment and ownership status from captured digital data, identify non-owned and complementary products, and provide highly relevant new product proposals tailored to the user's interests and the condition of owned products.

The term “processor” refers to any hardware or combination of hardware and software configured to execute instructions, including but not limited to a central processing unit (CPU), a graphics processing unit (GPU), a microcontroller, an application-specific integrated circuit (ASIC), a system-on-chip (SoC), or a distributed computing environment that collectively performs processing operations described in the claims.

The term “digital data” refers to any electronically encoded data representing content acquired by an imaging device, including but not limited to still images, video, depth data, infrared images, and associated metadata such as timestamps, geolocation, and imaging parameters.

The term “imaging device” refers to any device capable of capturing digital representations of a scene, including but not limited to a camera integrated in a smartphone, tablet, or wearable device, a digital still camera, a digital video camera, or a device having an image sensor for capturing images or video.

The term “preprocessing” refers to any operation performed on received digital data prior to input to a generative AI model, including but not limited to resizing, cropping, denoising, normalization, frame extraction from video, format conversion, feature extraction, and quality filtering.

The term “generative AI model” refers to any artificial intelligence model configured to generate outputs such as text, structured data, or other content in response to an input prompt, including but not limited to large language models, multimodal models that accept image and text inputs, and models trained using machine learning or deep learning techniques to generate recommendations, inferences, or descriptions.

The term “prompt” refers to any input data, including text, tokens, structured parameters, or a combination thereof, that is provided to a generative AI model to instruct the generative AI model to perform a specified task such as identifying information, inferring attributes, or generating product proposals.

The term “product information” refers to information characterizing a product, including but not limited to product category, brand, model name, model number, specifications, functions, size, capacity, performance level, and configuration.

The term “manufacturing information” refers to information related to production of a product, including but not limited to a manufacture date, manufacture year, production batch, production series, and associated version or generation of the product.

The term “deterioration information” refers to information indicating a state of wear, aging, or damage of a product, including but not limited to a qualitative condition label, a numerical deterioration score, an estimated remaining lifetime, or detected physical defects such as scratches, discoloration, or deformation.

The term “products not owned by the user” refers to products that are determined, based on analysis of digital data and optionally historical records, to be absent from the user's current possessions, including categories or specific items that are not detected in the user's environment and are not indicated as owned in purchase or registration data.

The term “new products” refers to products proposed to the user that are not currently owned by the user, including but not limited to upgrade products, alternative products, and complementary products that are suggested based on user interest, deterioration information of owned products, or compatibility with owned products.

The term “user's interest” refers to any inferred or explicit preference of the user, including but not limited to preferred categories, brands, functions, usage scenes, design styles, or budget ranges, derived from digital data, historical behavior, profile information, or prior interactions with recommendations.

The term “products owned by the user” refers to products that are determined, based on analysis of digital data and optionally purchase history or registration information, to be currently possessed by the user, including products visually detected in the captured environment and products associated with the user's account.

The term “products that are beneficial to use in combination” refers to products that, when used together with products owned by the user, provide functional, experiential, or convenience-related advantages, including but not limited to accessories, peripheral devices, compatible equipment, and coordinated items designed to complement the owned products.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

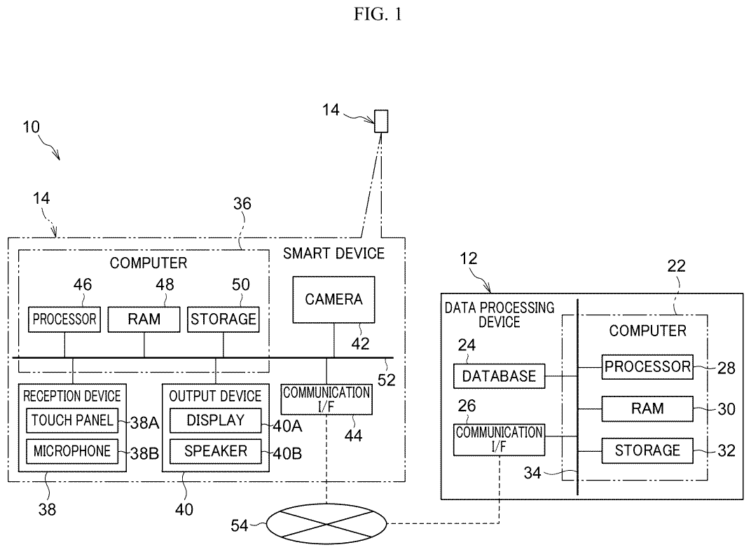

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

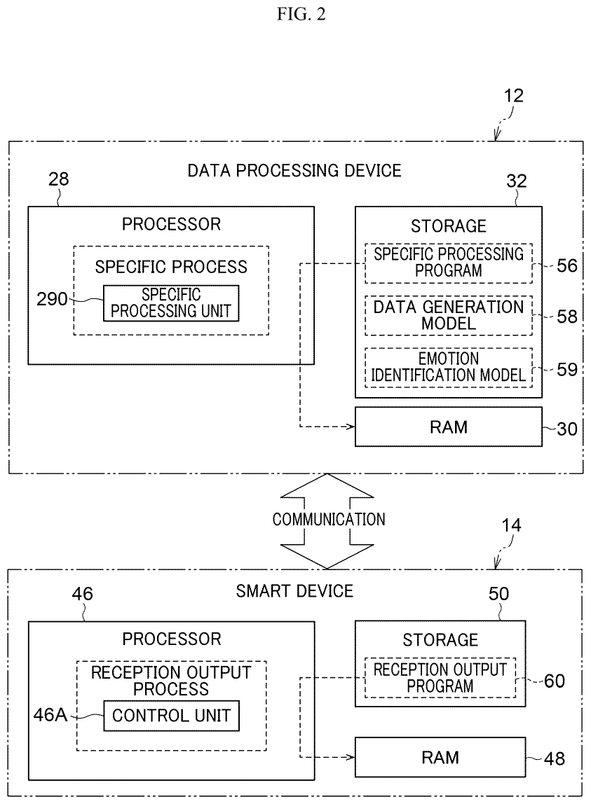

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recommendation systems and inventory management systems are typically configured to operate on explicitly registered item data, purchase logs, or simple catalog metadata. Such systems generally do not exploit raw image or video data capturing a user's physical environment, and therefore cannot automatically build an accurate, up-to-date representation of the user's actually owned items or their physical condition. As a result, a computing device must rely on incomplete or outdated records, which leads to suboptimal recommendations, redundant suggestions for items already owned, or missed opportunities to propose replacements for deteriorated items.

Moreover, known image analysis pipelines tend to be rigidly coded: a program extracts handcrafted visual features, applies fixed classification models, and directly outputs item labels. These pipelines do not flexibly combine visual analysis results, user profile information, and external catalog data in a unified, prompt-driven generation process.

Consequently, the computing device cannot adaptively change analysis granularity, target attributes (such as manufacturing details or deterioration level), or recommendation logic without extensive reprogramming. This limits the scalability and maintainability of the system and restricts the ability to rapidly update the logic when catalogs, user needs, or product categories evolve.

Further, conventional systems do not treat a generative AI model as a central orchestration component that is dynamically guided by prompt sentences automatically composed by a processor. In existing approaches, generative models, if used at all, often only provide natural language summaries at the end of a pipeline and are not tightly coupled with the core analytic and decision-making processes. As a result, the computing resources of the generative model are underutilized, and the host computer must implement complex rule-based logic to bridge between low-level image analysis and high-level recommendation behavior. This yields increased system complexity, higher latency, and greater maintenance burden.

Additionally, existing systems are not optimized to systematically integrate deterioration estimation, ownership determination, and category-based gap detection in a single, coherent computational workflow. Many implementations perform condition estimation in isolation, without tying it into the recommendation engine, or do not leverage condition scores to prioritize replacement suggestions. Accordingly, the computer fails to compute a structured index representing replacement priority or continued usability, and cannot generate targeted recommendations for alternative or complementary products that are specifically aligned with the user's current inventory and item conditions.

Therefore, there is a need for a technical framework that improves computer technology by enabling a processor to: (i) receive and preprocess visual digital data capturing a user's environment, (ii) automatically generate structured prompt sentences that instruct a generative AI model to extract product, manufacturing, and deterioration information, (iii) integrate such information with stored user inventory and purchase history, and (iv) compute and output optimized recommendations and explanations. Such a framework should reduce the amount of handcrafted logic, improve the adaptability and extensibility of the system, and enhance the overall efficiency and accuracy of computer-implemented recommendation and inventory analysis.

The specific processing by the specific processing unit 290 of the data processing device 12 in Example 1 is realized by the following means.

The present invention provides a server comprising a processor configured to receive, via a communication interface, digital data including image or video information of a physical space acquired using an imaging function of a user terminal; execute an image preprocessing module to perform at least pixel resolution conversion and noise reduction on the digital data and convert the preprocessed data into an analysis-ready data format; generate, based on the analysis-ready data, a first prompt sentence that instructs a generative AI model to extract product information, manufacturing information, and deterioration information, and supply the first prompt sentence and associated context to the generative AI model to obtain the product information, the manufacturing information, and the deterioration information; access user information storage that maintains current ownership information and purchase history information associated with the user, and, based on the extracted product information and deterioration information together with the ownership information and purchase history information, identify products not owned by the user, generate one or more additional prompt sentences that instruct the generative AI model to compute recommended products reflecting the user's interests and preferences, and supply the additional prompt sentences and structured context to the generative AI model to obtain recommended product information; compute, using the deterioration information and the ownership information, at least one index representing replacement priority or continued usability for each owned product and, in response, cause the generative AI model to propose alternative or complementary products aligned with the computed index; further generate prompt sentences that instruct the generative AI model to identify cooperative products which, when used in combination with the owned products, are expected to improve functionality or convenience, and obtain, from the generative AI model, recommended product information including such cooperative products; compare the recommended product information and the extracted product information with the ownership information to derive, by category or by use, groups of products not owned by the user; and construct response information including at least one of machine-generated explanatory text and structured list information based on the product information, the manufacturing information, the deterioration information, the computed indices, and the recommended product information, and transmit the response information to the user terminal. This enables the server to improve computer functionality by orchestrating image preprocessing, user-profile-aware analysis, and recommendation generation through dynamically constructed prompt sentences directed to a generative AI model, thereby reducing handcrafted rule complexity, increasing adaptability to evolving product data and user needs, and enhancing the accuracy, efficiency, and interpretability of automated inventory analysis and product recommendation processing.

The term “processor” refers to a hardware or virtual computation unit, such as a central processing unit, a graphics processing unit, or a combination thereof, configured to execute instructions of one or more programs to perform the functions described in the present disclosure.

The term “communication function” refers to hardware and software components, such as network interfaces and communication protocols, that enable transmission and reception of data between the server and external devices including user terminals.

The term “digital data” refers to electronically encoded information, including but not limited to image data and video data, representing a physical space captured by an imaging device.

The term “image information” refers to digital data representing one or more still images of a physical space, each still image being composed of pixels arranged in a two-dimensional array.

The term “video information” refers to digital data representing a sequence of images of a physical space over time, the sequence being encoded as moving picture data.

The term “information processing terminal” refers to an electronic device operated by a user, such as a smartphone, tablet, or personal computer, that includes at least an imaging function, a display function, and a communication function.

The term “imaging function” refers to a capability of the information processing terminal or an associated device to capture images or videos of a physical space by means of an optical sensor or similar sensing hardware.

The term “image processing program” refers to software configured to input digital image or video data and to perform operations such as resizing, color space conversion, noise reduction, and format conversion on the data.

The term “pixel count conversion process” refers to a processing operation that changes the spatial resolution of image data, including increasing or decreasing the number of pixels in at least one dimension.

The term “noise reduction process” refers to a processing operation applied to digital data to suppress or remove undesired variations, artifacts, or random fluctuations, thereby improving the quality of image or video data.

The term “analysis-ready data format” refers to a structured representation of digital data, such as a normalized tensor or array, adapted for efficient input to a machine learning model or other analytic algorithm.

The term “prompt sentence” refers to a text sequence or textual instruction automatically generated by the processor that specifies tasks, constraints, or desired outputs for a generative AI model.

The term “generative AI model” refers to a machine learning model, such as a neural network or large language model, configured to generate outputs including but not limited to text, structured data, or inferred attributes in response to prompt sentences and optional auxiliary inputs.

The term “product information” refers to attribute data associated with a product, including at least a category, a type, a brand, a model, or technical specifications inferred or determined from digital data and related resources.

The term “manufacturing information” refers to attribute data related to the production of a product, including at least a manufacturer, a manufacturing date, a manufacturing period, a series, or a production region.

The term “deterioration information” refers to data indicating a physical condition or wear state of a product, including qualitative or quantitative measures such as damage, discoloration, deformation, or usage-derived degradation.

The term “user information storage” refers to a data storage unit, such as a database or memory, that holds user-related data including ownership information, purchase history information, and preference information.

The term “holding product information” refers to data indicating which products are currently owned by a user, including identifiers, attributes, and associated metadata of such products.

The term “purchase history information” refers to data indicating past transactions or acquisitions by a user, including product identifiers, purchase dates, quantities, and optionally prices or sources.

The term “recommended product information” refers to data representing products suggested to the user by the system, including identifiers, categories, attributes, and optionally ranking scores or explanation-related metadata.

The term “interest and preference of the user” refers to inferred or stored user tendencies, likes, or constraints, including but not limited to favored categories, styles, brands, price ranges, or functional requirements.

The term “response information” refers to data generated by the processor for presentation to the user, including explanatory text, list information, tables, or other structured representations of analysis and recommendation results.

The term “explanatory text” refers to natural language sentences or paragraphs that describe analysis results, product conditions, and recommendation rationales in a human-readable manner.

The term “list information” refers to structured data organized in a list, table, or similar format, representing multiple items such as detected products, their attributes, conditions, or recommended alternatives.

The term “index indicating replacement priority” refers to a computed value or class that quantifies or categorizes how urgently a product should be replaced, based on deterioration information and optionally other factors.

The term “index indicating usability continuation” refers to a computed value or class that quantifies or categorizes whether and how long a product can continue to be used without replacement, based on deterioration information and optionally other factors.

The term “alternative product” refers to a product that can serve as a substitute for an owned product, providing substantially similar functionality or purpose.

The term “complementary product” refers to a product that, when used together with an owned product, enhances or extends the functionality, usability, or convenience of the owned product.

The term “cooperative product” refers to a product that is designed or suitable to operate or be used in combination with another product, such that the combined use provides improved functionality or convenience compared to using the products independently.

The term “category or use” refers to a classification dimension for grouping products, such as product type, function, application scene, or usage purpose.

The term “group of products not held by the user” refers to a set of products determined by comparing detected or cataloged products with holding product information, the set representing items identified as not currently owned by the user.

In one embodiment, the invention is implemented in a client-server architecture in which a server cooperates with one or more terminals operated by a user. The server includes at least one processor, a memory, a nonvolatile storage device, and a network interface. The terminal includes at least an imaging device, a display device, a user input device, a local storage device, and a communication interface. The server and the terminal communicate via a digital communication network such as the Internet using secure protocols.

The terminal uses an imaging device, such as a camera integrated in a smartphone or tablet, to capture image data or video data of a physical space including items owned by the user.

The terminal executes an operating system such as a mobile operating system or a desktop operating system, and the terminal invokes an imaging application programming interface (API) such as a camera framework to acquire frames from an image sensor. The terminal writes the image frames into a local storage device in a compressed format, for example a JPEG file for still images or an MP4 file for videos.

The user operates an application on the terminal to select image files or to capture new images of a room, a closet, or another storage area. The user optionally inputs a natural language prompt sentence into a text field rendered on the display of the terminal. The user may input, for example, the prompt sentence “Please analyze the items in my closet and tell me which clothes are worn out and what new items you recommend.” The terminal associates this prompt sentence with a set of selected image files in a local data structure, for example a record containing identifiers of the image files and a string representing the prompt sentence.

The terminal transmits the associated data to the server. The terminal uses an HTTP client library, such as a standard networking library provided by the operating system, to construct a request that includes the selected image files and the prompt sentence. The terminal attaches authentication information to the request and sends the request via a secure protocol such as HTTPS over a packet-switched network. The terminal thereby causes the server to receive digitized representations of the physical environment of the user.

The server receives the request via a network interface and passes the request to an application program executed by the processor. The server stores the received raw image files in a nonvolatile storage device, for example a file system or an object storage system. The server stores metadata in a database system such as a relational database, where the metadata includes a user identifier, a request identifier, file paths to the stored image files, timestamps, and the text of the received prompt sentence. The server uses these data structures to manage a plurality of concurrent analysis tasks.

The server employs an image processing software library such as an open-source image processing library running on the processor to perform preprocessing on the raw image data.

The server loads each image file from the storage device into main memory and decodes the compressed data into a multi-dimensional numerical array of pixel values. The server then performs pixel count conversion by resampling each image to a fixed resolution suitable for machine learning models, for example 512 by 512 pixels. The server also performs a color space conversion, for example from a device-specific color encoding into a standardized color space.

The server performs noise reduction on the decoded images by applying filtering operations, such as a Gaussian filter or a median filter, to the pixel arrays. These filtering operations remove small-scale, high-frequency noise that may adversely affect subsequent feature extraction and classification. The server may also perform contrast normalization, histogram equalization, or illumination correction to reduce variability due to lighting conditions. The server converts the resulting processed images into structured tensors represented as contiguous blocks of numerical values in memory, with a standard shape such as [batch size, height, width, channels].

In one embodiment, the server uses hardware acceleration for these operations by executing the image processing functions on a graphics processing unit (GPU) via a parallel computing framework. The server thereby reduces latency and increases throughput when processing large numbers of images or high-resolution video frames. The server stores references to the preprocessed tensors in a task context structure, which is passed to subsequent analysis modules.

The server uses one or more trained neural network models to analyze the preprocessed image data. In one embodiment, the server uses a convolutional neural network or a vision transformer network implemented with a deep learning framework such as a general-purpose tensor computation framework. The server loads model parameters into GPU memory and executes the forward pass of the neural network on the preprocessed tensors. The neural network is configured to output, for each image, a set of feature maps and classification probabilities corresponding to product categories, item types, and region proposals (bounding boxes).

The server performs object detection by interpreting the network output as proposals for bounding boxes of individual products in the image. The server uses non-maximum suppression and thresholding on confidence scores to select a set of bounding boxes representing detected products. For each bounding box, the server crops a sub-image from the preprocessed image tensor and resizes the sub-image to an input size expected by subsequent models.

The server applies an optical character recognition (OCR) module to regions that appear to contain textual labels, brand logos, or model numbers. The server uses a specialized OCR engine that converts image patches into sequences of characters by a combination of convolutional layers and recurrent or transformer layers. The server outputs recognized text strings which may include brand names, product series names, or alphanumeric identifiers.

The server uses these visual and textual features as input to a classification module. The server concatenates numeric feature vectors extracted from intermediate layers of the detection model with embeddings of recognized text. The server feeds these combined feature vectors into a fully connected neural network that outputs predicted product categories, estimated brand identifiers, and model identifiers. The server stores the predicted attributes for each detected item in an internal representation such as a list of product records, where each record includes an item identifier, bounding box coordinates, a category code, one or more candidate brand codes with probabilities, and recognized text strings.

The server accesses a product catalog database that stores structured product information and manufacturing information. The server formulates queries to the database by using recognized brand and model identifiers, and by using similarity search methods for partially matched strings. The server retrieves candidate catalog entries that match the detected attributes. The server computes similarity scores between the feature vectors extracted from the image and embedding vectors associated with catalog entries. The server selects the most similar catalog entries as the final product information and manufacturing information for each detected item and writes the selected information into the product records.

The server estimates deterioration information using a dedicated neural network. In one embodiment, the server uses a convolutional neural network trained on labeled images of products with known wear states. The server inputs the cropped sub-images of each detected product into this network. The network outputs a numerical deterioration score within a predetermined range, and may also output class labels such as “good,” “moderate,” or “poor,” and auxiliary labels indicating types of damage such as fraying, discoloration, or structural deformation. The server stores the deterioration information and associates it with each product record.

The server accesses user information storage that contains historical ownership and purchase records. The server compares newly detected product information with stored ownership information to identify items currently owned by the user, items newly detected but likely to be owned, and categories for which no owned items are found. The server determines an index representing replacement priority for each owned product by combining the deterioration score, product age (based on manufacturing information and purchase history), and category-specific lifespan parameters. The server also computes an index representing usability continuation indicating how long an item can be used before it is likely to require replacement.

The server uses the above product information, manufacturing information, deterioration information, and computed indices as input context for a generative AI model. In one embodiment, the generative AI model is a large language model implemented as a transformer neural network with multiple self-attention layers, feedforward layers, and learned token embeddings. The server stores the model parameters as weight matrices and bias vectors in memory and executes the model on a GPU or specialized accelerator.

The server does not rely solely on manually authored natural language templates. Instead, the server generates prompt sentences programmatically, based on the structured analysis results.

The server constructs a first prompt sentence that expresses, in natural language, a request to extract product information, manufacturing information, and deterioration information from the preprocessed data. The server can embed structured data in the prompt using a controlled format, while still presenting it as textual content to the generative AI model. For example, the server may construct a prompt sentence including text such as:

“Given the following detected items with visual features and recognized text, identify for each item the product type, manufacturer, approximate manufacturing period, and condition level.”

The server then appends summarized features or labels to the prompt.

The server generates further prompt sentences to obtain recommended products. The server analyzes the user's preferences and past purchase history and constructs prompt sentences that instruct the generative AI model to propose new items. For example, the server may generate a prompt sentence such as:

“Based on this user's wardrobe items and their current condition, recommend three new clothing items that the user does not own, matched to this user's style and typical price range.”

The server can also generate prompt sentences focusing on a specific type of recommendation, for example:

“Only show items that should be replaced within the next six months and recommend affordable alternatives under 50 dollars.”

The server supplies these prompt sentences, together with a compact representation of the inventory and deterioration indices, as input tokens to the generative AI model. The server uses a tokenizer to convert the text into discrete token identifiers and feeds token sequences into the transformer network. The network computes attention weights, intermediate hidden states, and output token probabilities according to its learned parameters. The server samples or decodes the output tokens according to a decoding strategy such as greedy decoding or beam search. The server thereby obtains natural language segments that describe the condition of the user's items, identify gaps in the inventory, and recommend new products.

The server combines the generative outputs with structured data produced by deterministic modules. The server generates response information including one or more of the following: product lists with attributes and deterioration scores, table-like structures listing replacement priorities, and explanatory paragraphs summarizing the analysis. The server organizes the response information as a hierarchical data object and serializes it into a structured format for transmission to the terminal.

The terminal receives the response information and parses it into internal data structures. The terminal presents a graphical user interface on its display device to show the analysis results.

The terminal renders, for example, a list of detected items with labels such as “Good condition,” “Moderate wear,” and “Replace soon,” and shows recommended new items underneath the items in poor condition. The terminal also displays the natural language explanation produced by the generative AI model, such as a message explaining why certain replacements or complementary products are recommended. The user can interact with the displayed content by scrolling, selecting items, or issuing further prompt sentences through the input interface.

The described configuration improves computer technology beyond mere automation of human work in several ways. The server exploits specialized data structures and hardware acceleration to handle raw image data and high-dimensional tensors, thereby reducing computation time relative to naïve implementations that would use generic image loading and unoptimized loops on a central processing unit. The server integrates image preprocessing, feature extraction, catalog lookup, deterioration scoring, and generative reasoning through a pipeline that minimizes redundant data transfers and avoids repeated decoding of image files, thus reducing memory usage and network overhead within the system.

The server uses the generative AI model not only as a text generator, but as a programmable decision engine whose behavior is controlled via dynamically generated prompt sentences.

This control mechanism allows the server to offload complex heuristic reasoning about item importance, replacement timing, and category-based gaps from brittle, handcrafted rule sets into a learned model that can encode patterns across many users and product types. The server thereby simplifies the logic implemented in procedural code and reduces maintenance overhead, while at the same time enabling sophisticated personalization that would be difficult to implement with fixed rules.

The server computes explicit indices such as replacement priority and usability continuation, which are numeric values derived from deterioration scores, product age, and category-specific parameters. These indices are stored as fields in product records and are used as conditioning variables for both deterministic filters and generative prompts. This structured approach enables the server to sort and filter items efficiently in the database layer, reduces the volume of data that must be sent to the generative AI model, and allows the model to focus on high-level reasoning. As a result, the overall system achieves higher throughput and lower latency when serving multiple users.

The server's use of nonconventional prompt generation is particularly important for technical improvement. Instead of treating the prompt as a static user input, the server programmatically assembles prompt sentences that encode internal data structures such as deterioration indices, ownership sets, and category gaps. This design allows the generative AI model to perform complex multi-criteria ranking and explanation tasks that would otherwise require multiple separate models or extensive rule-based processing. The server thereby exploits the parallel processing capabilities and representational power of the transformer architecture to perform inference over structured inventory data.

In one embodiment, the neural networks used for detection and deterioration estimation are trained offline using supervised learning. The server or a training system uses a training dataset consisting of images of products with annotated categories, manufacturing data, and wear levels. The training process employs a loss function composed of classification loss, bounding box regression loss, and deterioration prediction loss. The system updates model weights by backpropagation and gradient-based optimization algorithms such as stochastic gradient descent or adaptive optimization methods. Data augmentation techniques, such as random cropping, rotation, color jitter, and additive noise, are used to increase robustness to environmental variations. These training procedures result in models that can accurately infer product types and deterioration states from noisy real-world images, which in turn improves the reliability of subsequent recommendation and explanation steps.

In an alternative embodiment, the server uses a different neural network architecture, such as a unified transformer-based vision model for both detection and deterioration estimation, or a combination of convolutional backbones and attention layers for improved robustness. In another variation, the server deploys separate generative AI models for different product categories, and selects an appropriate model based on the detected category in the pre-analysis stage, thereby optimizing inference time and memory usage.

The server may also implement compression and caching strategies to further reduce communication overhead and computation load. The server can cache preprocessed image tensors and intermediate feature maps keyed by a hash of the raw image data, so that repeated analyses of the same image do not require full recomputation. The server may send only identifiers or summary scores to the generative AI model when detailed pixel-level information is not required, thereby reducing input sequence length and inference cost. These techniques collectively enhance system efficiency and scaling characteristics.

The terminal benefits from the server's optimized processing by receiving concise and actionable results rather than raw data. Because the heavy computations, such as feature extraction, deterioration estimation, and generative reasoning, are executed on specialized server hardware, the terminal can be a resource-constrained device such as a smartphone while still providing advanced inventory analysis functions. This arrangement allows wider deployment and improves user experience by maintaining acceptable response times even when processing large numbers of images.

The described embodiments are not limited to specific hardware or software brands. The server may use any equivalent image processing library, neural network framework, or database system that can provide similar functionality, and the terminal may be any computing device with an imaging function and communication capability. The architecture can be implemented using different topologies, such as multiple servers with load balancing or distributed model serving across several accelerator devices. The system can also support additional prompt sentences and recommendation strategies without changing the fundamental pipeline: the server programmatically extends the set of prompt templates, adjusts their contents based on stored indices and metadata, and leverages the generative AI model to produce corresponding outputs.

By combining specialized image processing, structured data modeling, neural network inference, and dynamic prompt-driven generative reasoning in a tightly integrated pipeline, the system improves the technical operation of computers for inventory analysis and recommendation. The server processes data in ways that are not practicable for a human to replicate manually at comparable speed and scale, and the system achieves measurable improvements in classification accuracy, deterioration estimation reliability, recommendation relevance, and latency, thereby demonstrating a concrete technological advance rather than a mere automation of a human mental process.

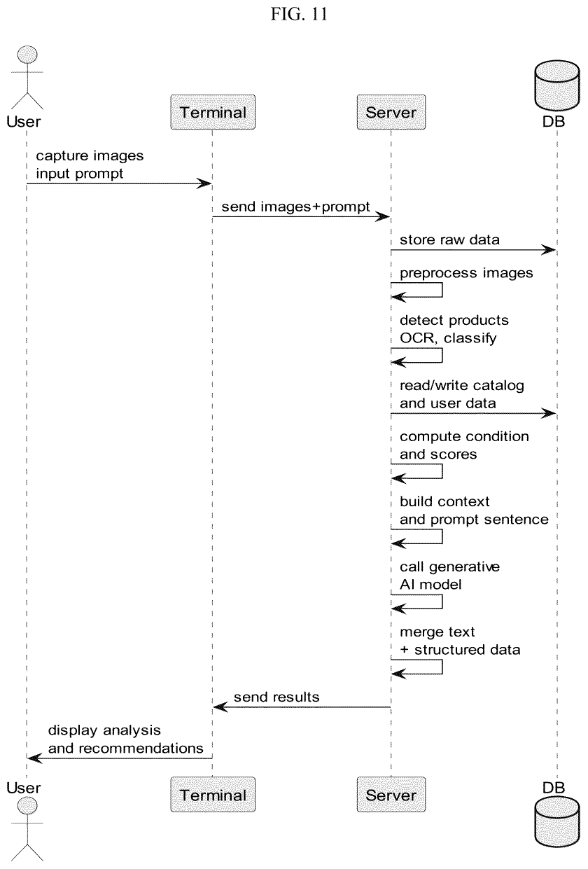

The following describes the processing flow using FIG. 11.

### Step 1:

The user operates an application on the terminal to capture or select images or videos.

The terminal activates a camera component and acquires raw sensor frames as input.

The terminal encodes the frames into digital data, such as JPEG images or MP4 video files, and stores file paths and basic metadata (timestamp, resolution, orientation) as output.

### Step 2:

The user inputs a prompt sentence via a text input field displayed on the terminal.

The terminal takes the prompt sentence as input and associates it with the selected image or video file identifiers in an internal record.

The terminal outputs a combined data structure comprising the file identifiers, the prompt sentence, and user authentication data.

### Step 3:

The terminal prepares a network request to send the combined data to the server.

The terminal uses the image or video files and the associated prompt sentence as input and constructs an HTTPS request body using multipart/form-data or an equivalent encoding.

The terminal outputs the HTTPS request and transmits it via the communication interface to an API endpoint on the server.

### Step 4:

The server receives the HTTPS request through its network interface.

The server takes the raw HTTP payload as input and parses headers, multipart sections, and body fields using a server-side framework.

The server outputs separated components: binary image or video data, the prompt sentence text, user identifiers, and metadata needed for subsequent processing.

### Step 5:

The server stores the received binary data in persistent storage.

The server takes the decoded image or video bytes as input and writes them to a file system or object store, generating storage paths or object keys.

The server outputs persistent references (such as file paths or object identifiers) and creates a database record linking the references with the user ID and the prompt sentence.

### Step 6:

The server performs image decoding and preprocessing using an image processing library.

The server takes as input the stored file references and reads the corresponding binary image or video data into memory, decodes the data into pixel arrays, resizes each image to a standard resolution, converts the color space, and applies noise reduction filters.

The server outputs normalized tensors or arrays representing the preprocessed images, and updates the task context with these in-memory tensor references.

### Step 7:

The server extracts frames from video input when necessary.

The server takes decoded video streams as input and samples frames at a configured temporal interval, such as one frame per second, then applies the same resize, color conversion, and noise reduction operations to each frame.

The server outputs a batch of frame tensors, along with frame indices and timestamps, which are used as input for downstream analysis modules.

### Step 8:

The server performs object detection to identify candidate products in the images.

The server uses the batch of image or frame tensors as input and runs a trained detection network, such as a convolutional or transformer-based detector, to compute feature maps, bounding boxes, and class scores.

The server outputs a set of detection results, each including a bounding box, a predicted category label, and a confidence score, after applying non-maximum suppression and thresholding.

### Step 9:

The server crops product regions and prepares them for fine-grained analysis.

The server takes the original preprocessed images and the bounding boxes as input and extracts sub-images corresponding to each detected product, then resizes these sub-images to a canonical size required by attribute and deterioration models.

The server outputs a collection of product-region tensors, each tagged with a detection ID and category label.

### Step 10:

The server performs text extraction from product regions by optical character recognition.

The server uses the product-region tensors as input and applies an OCR pipeline to regions likely to contain labels or logos, converting local pixel patterns into character sequences.

The server outputs recognized text strings, such as brand names, model numbers, or size indicators, and associates these strings with the corresponding detection IDs.

### Step 11:

The server classifies product attributes based on visual and textual features.

The server takes as input visual feature vectors extracted from intermediate layers of the detection network and embedding vectors derived from recognized text, and concatenates these vectors into composite feature representations.

The server passes the composite features through a classification network and outputs structured product attributes including product type, brand code, model code, and confidence scores for each attribute.

### Step 12:

The server performs catalog lookup to enrich product information.

The server uses as input the predicted brand and model codes, product category labels, and recognized text, and issues database queries or similarity searches against a product catalog.

The server outputs matched catalog entries that include detailed product information and manufacturing information, and updates each product record with catalog IDs, manufacturer names, and estimated manufacturing periods.

### Step 13:

The server estimates deterioration states of detected products.

The server takes the product-region tensors and associated catalog attributes as input and runs a deterioration estimation network that outputs a numerical wear score and categorical condition labels.

The server outputs deterioration information, including overall condition class, wear score, and indicators of specific defects such as discoloration or fraying, and stores these values in the product records.

### Step 14:

The server computes indices for replacement priority and usability continuation.

The server uses deterioration scores, estimated product age (derived from manufacturing information and purchase history), and category-specific lifespan parameters as input to a scoring algorithm.

The server outputs, for each owned product, a replacement priority index and a usability continuation index, and records these indices in structured fields used for ranking and filtering.

### Step 15:

The server determines current ownership and identifies gaps in the user's inventory.

The server takes as input the updated product records from the current analysis and the user's existing ownership and purchase history records from user information storage, and performs matching based on brand codes, model codes, and similarity scores.

The server outputs a partition of items into owned products, newly recognized but previously unregistered products, and missing categories where no owned items are found or where items are in poor condition.

### Step 16:

The server selects candidate products for recommendation based on computed indices and gaps.

The server uses the ownership partition, replacement priority indices, usability indices, and category gaps as input and executes deterministic filters to target products needing replacement or categories lacking items.

The server outputs a set of recommendation targets described by category, desired attributes, and constraints such as budget or style preferences inferred from user history.

### Step 17:

The server constructs structured context for generative reasoning.

The server takes as input the recommendation targets, product attributes, manufacturing information, deterioration information, and user preference data, and converts them into a compact structured representation, such as key-value pairs or serialized attribute lists.

The server outputs a context object that can be serialized to text and embedded into prompt sentences for the generative AI model.

### Step 18:

The server generates a first prompt sentence to request high-level analysis and summarization.

The server uses the context object and the original user prompt sentence as input and programmatically composes a new prompt sentence that instructs the generative AI model to describe product conditions and inventory status.

The server outputs a combined textual prompt, for example: “Given the following list of items with categories, ages, and condition scores, explain which items are in poor condition and summarize the user's current inventory.”

### Step 19:

The server generates additional prompt sentences to request personalized recommendations.

The server takes as input the recommendation targets and user preference data and constructs prompt sentences that specify constraints such as price range, style, or replacement urgency.

The server outputs prompt sentences such as “Based on this user's wardrobe items and their current condition, recommend three new clothing items that the user does not own, matched to this user's style and typical price range.”

### Step 20:

The server performs tokenization and input preparation for the generative AI model.

The server uses the constructed prompt sentences and serialized context text as input and applies a tokenizer to convert the text into sequences of discrete token IDs, adding special tokens required by the model architecture.

The server outputs token sequences and attention masks that define the input for the generative AI model's encoder-decoder or decoder-only structure.

### Step 21:

The server executes inference on the generative AI model.

The server takes token sequences and attention masks as input and runs the transformer-based generative AI model on a processing unit configured for matrix operations, computing attention weights and hidden states across multiple layers.

The server outputs sequences of output tokens representing generated natural language content that includes explanations of product conditions, justifications for replacement, and lists of recommended products with rationale.

### Step 22:

The server decodes token sequences into natural language text.

The server uses the output token sequences as input and maps each token ID back to a text segment using the model's vocabulary, applying a decoding strategy such as greedy selection or beam search with constraints to control length and style.

The server outputs one or more natural language strings, such as explanatory paragraphs and bullet-style recommendation descriptions.

### Step 23:

The server merges generative outputs with structured recommendation data.

The server takes as input the generated text, the underlying recommended product identifiers from catalog lookup, and the computed indices, and composes a response object that combines structured fields with free-form explanations.

The server outputs a composite response that includes item lists, recommended product entries with identifiers and links, and textual sections describing the reasoning behind each suggestion.

### Step 24:

The server serializes and transmits the response to the terminal.

The server uses the composite response object as input and converts it into a structured interchange format, such as a JSON document, then attaches this document to an HTTP response and sends it via HTTPS to the terminal.

The server outputs a network response packet containing the full analysis and recommendations.

### Step 25:

The terminal receives and parses the response from the server.

The terminal takes the HTTP response as input and uses a JSON parser to transform the payload into local objects that store product lists, condition ratings, indices, and generated explanations.

The terminal outputs in-memory data structures ready to be rendered on the display.

### Step 26:

The terminal renders the analysis and recommendations to the user.

The terminal uses the parsed data structures as input and generates a graphical user interface that lists detected products, displays condition labels, shows replacement priority indicators, and presents recommended new products with associated details and the generative AI model's explanatory text.

The terminal outputs rendered screens and interactive elements that the user can view and manipulate through touch or pointer input.

### Step 27:

The user reviews the displayed results and optionally refines the request.

The user takes the on-screen information as input and, if needed, enters additional prompt sentences, such as “Only show products that should be replaced within the next six months and recommend affordable alternatives under 50 dollars.”

The user causes the terminal to output a new request containing the additional prompt sentence and references to prior analysis results, which the server can use as input to repeat or refine the processing pipeline.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented product recommendation systems typically rely on manually entered catalog data, structured user profiles, and transaction histories. Such systems are not designed to ingest raw image information or video information of physical spaces and products, and therefore cannot automatically construct or update a user's inventory of owned products, detect degradation states of physical products, or reconcile such states with real-time in-store inventory. As a result, the underlying computer processes are limited to static, coarse-grained data models that are unable to take advantage of rich visual information available from cameras and other image acquisition devices.

Moreover, existing systems that use machine learning or artificial intelligence models generally treat such models as black-box classifiers or predictors, with fixed input formats and labels. These systems do not dynamically generate prompt sentences that instruct a generative AI model in detail regarding the desired analysis, output structure, and recommendation objectives, nor do they orchestrate multiple, different prompt sentences across different phases of data processing (e.g., extraction of product information, inventory analysis, and recommendation generation). Consequently, the computer cannot flexibly adapt its processing flow to heterogeneous visual inputs, changing user contexts, and real-time store conditions, which leads to inefficiencies in computation and reduced relevance of recommendations.

Further, conventional inventory management and product recommendation engines operate as separate subsystems. Inventory management systems typically maintain structured stock data but do not integrate visual analysis of product degradation or shelf conditions.

Recommendation engines typically generate suggestions without directly reflecting real-time physical conditions such as near-expiration items or visually damaged products. This separation forces duplication of data processing, requires additional manual updates, and constrains the computer architecture to siloed data flows, resulting in increased processing overhead, latency, and a higher risk of stale or inconsistent data being used for decision making.

In addition, in many existing implementations, terminal devices are used merely as thin clients for sending generic queries or receiving static recommendation lists. They are not integrated into an end-to-end pipeline where terminal-side scanning, real-time transmission of store product information, and server-side generative AI processing cooperate to maintain a continuously updated, visually grounded model of both user-owned products and in-store products. This lack of integration prevents the overall computer system from achieving improved utilization of network bandwidth, optimized server-side computation scheduling, and context-aware generation of proposals tailored to each user session and store environment.

Accordingly, there is a need for an improved computer-implemented system and method that (i) programmatically constructs and updates prompt sentences for a generative AI model based on preprocessed visual data and stored product information data, (ii) unifies user-side inventory extraction, degradation detection, and store-side inventory analysis within a single processing pipeline, and (iii) generates and delivers product proposals in a manner that enhances the efficiency, accuracy, and adaptability of the underlying computer system itself.

The technical problem is to improve how computers acquire, interpret, and act upon heterogeneous visual and inventory data by leveraging generative AI models through dynamically generated prompt sentences, thereby improving the functioning of the computer system in terms of data processing efficiency, resource utilization, and quality of automated decision support.

The specific processing by the specific processing unit 290 of the data processing device 12 in Application Example 1 is realized by the following means.

The present invention provides a server comprising a processor, a memory, and a communication interface, the processor being configured to receive, via the communication interface and a communication network, digital information including image information or video information acquired by a user using an image acquisition device or a video acquisition device, perform preprocessing including pixel count conversion, frame extraction, and image quality correction on the digital information to generate preprocessed visual data, generate a first prompt sentence describing analysis contents for specifying product attribute information, manufacturing date information, and degradation state information, input the first prompt sentence together with the preprocessed visual data to a generative AI model, acquire product information data including the product attribute information, the manufacturing date information, and the degradation state information from the generative AI model, and store the acquired product information data in the memory as structured records associated with a user identifier; the processor being further configured to execute inventory analysis based on the stored product information data by identifying a group of products owned by the user and extracting products not included in the group of products and missing products in categories of the group of products, generate a second prompt sentence describing analysis conditions and an output format for causing the generative AI model to generate recommendation candidates including products not owned by the user, high-performance alternative products, and complementary products that are beneficial to use in combination with the owned products, input the second prompt sentence and at least a portion of the product information data to the generative AI model, acquire recommendation candidate information from the generative AI model, and associate the acquired recommendation candidate information with merchandise management information stored in the memory; the processor being further configured to generate a merchandise proposal message for the user based on the recommendation candidate information and the merchandise management information, transmit the merchandise proposal message via a communication application to a terminal device having a display device, receive, via the communication interface, store product information including products placed in a store, the store product information being acquired by the terminal device scanning the products using an imaging function for reading or a code reading function for identification and transmitted from the terminal device in real time, generate a third prompt sentence describing analysis contents for specifying an in-store inventory state and a degradation state of in-store products based on the store product information and inventory management information stored in the memory, input the third prompt sentence and the store product information to the generative AI model, acquire in-store merchandise proposal information for proposing optimal products to visitors from the generative AI model, and provide the in-store merchandise proposal information to at least one terminal device for presentation to a visitor. This enables the computer system to dynamically orchestrate preprocessing, prompt sentence generation, generative AI inference, and structured data storage in an integrated pipeline that improves the accuracy and timeliness of product information extraction, reduces manual data entry, enhances real-time responsiveness of inventory and degradation analysis, and optimizes the generation and delivery of personalized product proposals by leveraging the capabilities of the generative AI model in a manner that improves the overall functioning of the server and associated terminal devices.

The term “system” refers to an arrangement including at least one server, at least one terminal device, and one or more storage and communication components that cooperate to execute the processing described in the claims.

The term “processor” refers to one or more hardware processing units, such as a central processing unit or a graphics processing unit, configured to execute instructions stored in a memory to perform the operations recited in the claims.

The term “memory” refers to one or more hardware storage media, such as volatile memory or non-volatile memory, configured to store instructions, models, and data used by the processor.

The term “communication interface” refers to a hardware and software combination that enables the server or the terminal device to exchange data over a communication network using one or more communication protocols.

The term “communication network” refers to any wired or wireless data network, including a local area network, a wide area network, or a public network, that enables data transmission between the server and the terminal device.

The term “terminal device” refers to an information processing device operated by a user or store staff, such as a portable communication device, a wearable device, or a computing terminal, that includes at least a display device and a communication function.

The term “display device” refers to a hardware component, such as a display panel or a head-mounted display, configured to present visual information to a user.

The term “user” refers to an individual or an organization that operates a terminal device to capture images or videos, receive merchandise proposal messages, and interact with the system.

The term “visitor” refers to a user or a person located in a store environment who is a potential recipient of in-store merchandise proposal information.

The term “image acquisition device” refers to a device including an image sensor configured to capture still image information of a physical space or product.

The term “video acquisition device” refers to a device including an image sensor configured to capture moving image information of a physical space or product.

The term “digital information” refers to electronic data including at least image information or video information captured by an image acquisition device or a video acquisition device.

The term “image information” refers to data representing at least one still image frame of a scene including one or more products or environments.

The term “video information” refers to data representing a time sequence of image frames depicting one or more products or environments.

The term “preprocessing” refers to one or more operations performed on digital information prior to analysis, including at least pixel count conversion, frame extraction, and image quality correction.

The term “pixel count conversion” refers to an operation that changes the spatial resolution or the number of pixels of image information to a target resolution suitable for analysis.

The term “frame extraction” refers to an operation that selects one or more representative image frames from video information based on temporal intervals or other criteria.

The term “image quality correction” refers to an operation that adjusts one or more aspects of image information, such as brightness, contrast, noise level, or color balance, to improve suitability for analysis.

The term “preprocessed visual data” refers to image information or video-derived frames that have been subjected to preprocessing.

The term “generative AI model” refers to an artificial intelligence model implemented by software running on hardware that is configured to receive at least one of text and visual data as input and to generate at least one of text and structured data as output, including models based on deep learning architectures.

The term “prompt sentence” refers to text information that describes analysis contents, analysis conditions, or output formats and is supplied as input to a generative AI model to control the behavior or output of the generative AI model.

The term “product attribute information” refers to information describing one or more characteristics of a product, including at least a category, a type, a capacity, a size, a material, or a brand-type designation.

The term “manufacturing date information” refers to information indicating a date or time period associated with manufacturing, production, or packaging of a product.

The term “degradation state information” refers to information indicating a physical condition or level of deterioration of a product, including at least wear, damage, discoloration, deformation, or proximity to an expiration condition.

The term “product information data” refers to structured data including at least product attribute information, manufacturing date information, and degradation state information extracted from image information or video information.

The term “storage device” refers to one or more hardware storage units, including local or remote storage, configured to store product information data, merchandise management information, and other data used by the system.

The term “group of products owned by the user” refers to a set of products identified as being possessed or controlled by the user, based on product information data and associations with a user identifier.

The term “inventory analysis” refers to processing that determines at least which products are included in the group of products owned by the user, which products are not included, and which products are missing in one or more product categories.

The term “products not owned by the user” refers to products that are not included in the group of products owned by the user, as determined by inventory analysis.

The term “missing products” refers to products that are not present in the group of products owned by the user but belong to product categories that are determined to be underrepresented or absent.

The term “high-performance alternative products” refers to products proposed as replacements for existing products, the replacements having improved performance with respect to at least one attribute such as functionality, efficiency, or durability.

The term “complementary products” refers to products that are functionally or practically related to products in the group of products owned by the user such that combined use of the products increases convenience, functionality, or overall value.

The term “recommendation candidates” refers to products or product sets output by the generative AI model in response to a prompt sentence and used for generating merchandise proposals.

The term “recommendation candidate information” refers to structured data describing recommendation candidates, including identifiers, categories, and reasons for recommendation.

The term “merchandise management information” refers to structured data representing at least product identifiers, pricing, availability, and classification used for managing products within the system or a store.

The term “merchandise proposal message” refers to information generated for presentation to a user that includes at least one recommended product and may include explanatory information, pricing, and links or identifiers for acquisition.

The term “communication application” refers to application software configured to transmit and receive messages via a communication network, including at least a messaging application, a notification service, or a dedicated client application.

The term “store product information” refers to information related to products placed in a store, including at least identifiers, locations, and captured visual or code-based representations acquired by a terminal device.

The term “imaging function for reading” refers to a function of a terminal device that uses an image sensor to capture an image of a product or a product label for subsequent analysis.

The term “code reading function for identification” refers to a function of a terminal device that reads codes, such as barcodes or matrix codes, to identify products.

The term “real time” refers to data transmission and processing that occur with a latency sufficiently low to reflect the current state of products or inventory within an operational time frame acceptable for immediate decision making.

The term “inventory management information” refers to structured data representing stock levels, storage locations, and movement of products in a store or warehouse.

The term “in-store inventory state” refers to information describing current quantities, placement, and availability of products in a store.

The term “in-store merchandise proposal information” refers to information generated for presentation to a visitor in a store, including at least recommended products based on in-store inventory state and degradation state information.

The term “ownership state information” refers to information describing, for a group of products owned by the user, at least category information, usage purpose information, and usage environment information.

The term “category information” refers to information that classifies products into types or groups according to function, use, or other attributes.

The term “usage purpose information” refers to information describing the intended or typical use cases of a product.

The term “usage environment information” refers to information describing physical or contextual environments in which products are used, such as indoor, outdoor, office, or household environments.

The term “deadline information” refers to information indicating a temporal limit or expiration, including at least an expiration date or best-before date associated with a product.

The term “degree of degradation” refers to a level or severity measure of physical deterioration of a product, which may be represented by discrete levels or continuous values.

The term “proximity to an expiration time” refers to a measure indicating how close a product is to a deadline information value, such as an expiration date.

The term “replacement products” refers to products proposed for substituting existing products that meet certain degradation or expiration conditions.

The term “products having price advantages” refers to products proposed at least in part because they have favorable pricing conditions, such as discounts or lower cost relative to alternatives.

The term “system configuration” refers to a combination of hardware components, software components, and data flows forming the overall arrangement of the system described in the claims.

In one embodiment, a server, a terminal, and a user cooperate to implement the invention. The server includes at least one processor, a memory, a communication interface, and access to non-volatile storage. The terminal includes at least one processor, a memory, a communication interface, an image acquisition device such as a camera, and a display device such as a touch screen or a head-mounted display. The user operates the terminal to capture images or videos of physical spaces containing products, to receive product proposals, and to interact with displayed information.

The server uses general-purpose computing hardware, such as a multi-core central processing unit and, optionally, a graphics processing unit or a tensor processing unit, mounted on a computing platform. The server executes an operating system such as a general-purpose server operating system and application software implemented using a programming language. The server accesses a storage system such as a block storage device or an object storage service to store image data, product information data, and model parameters. The terminal uses an operating system such as a mobile operating system and executes an application that controls a camera and a communication function.

The server uses software modules including a communication module, a preprocessing module, a prompt generation module, a generative AI model interface module, an inventory analysis module, a recommendation generation module, and a message formatting module.

The generative AI model interface module communicates with a generative AI model deployed on a model serving environment, such as a containerized inference server, and the model is implemented using a deep learning framework such as a tensor-based numerical computation library.

The terminal uses software modules including a camera control module, a local storage module, a user interface module, and a communication client module. The camera control module acquires raw sensor data from the image acquisition device, the local storage module stores captured images or videos, and the communication client module transmits and receives data via a communication network such as a wireless network or a wired network.

The server uses the preprocessing module to apply concrete data transformations to raw digital information received from the terminal. The preprocessing module converts the spatial resolution of images by performing pixel count conversion using interpolation filters, extracts key frames from videos at fixed time intervals, adjusts contrast and brightness through linear transformations, and removes noise using convolution-based filters. The server stores the resulting preprocessed visual data in memory structures such as multi-dimensional arrays or tensor objects and associates them with metadata such as a user identifier, a capture timestamp, and a location.

The server uses the prompt generation module to construct prompt sentences in natural language. The prompt generation module reads structured configuration data describing desired analysis types and output formats and combines this configuration with context data such as user preferences and inventory status to create specific, parameterized prompt sentences. For example, the server can generate a prompt sentence of the form:

“Given these images of household items, identify each visible product, extract product category, brand, size, and material, read any visible manufacturing or expiration dates on labels, and estimate the degradation state (new, slightly used, heavily worn). Return your findings in a structured textual list that clearly separates each product.”

The server passes the prompt sentence and the preprocessed visual data to the generative AI model interface module. The generative AI model interface module encodes images into feature representations and converts the prompt sentence into token sequences, then submits both to the generative AI model. In one embodiment, the generative AI model is a multimodal transformer-based neural network having an image encoder and a text encoder, where the image encoder can be a vision transformer or a convolutional neural network, and the text encoder can be a transformer-based language model. The model uses an attention mechanism to integrate visual features and textual tokens and generates output tokens representing detailed descriptions and structured product information.

The server uses concrete internal data structures to manage the output of the generative AI model. The server parses the textual output into a product information data record that includes fields such as product attribute information, manufacturing date information, degradation state information, and product location information in the image. The server stores each record in a database, where each record is associated with a unique identifier and a user identifier. The server maintains indexes on product categories and degradation states to enable efficient queries and updates.

The server uses an inventory analysis module to operate on the stored product information data in order to build a representation of the user's owned products. The inventory analysis module groups records by normalized product categories and merges multiple detections of the same product using similarity metrics based on attribute fields and image features. The server computes a set that represents the group of products owned by the user and identifies missing products in underrepresented categories by comparing the user's set against reference category templates stored in the database.

The server uses the prompt generation module to create further prompt sentences for recommendation. For example, the server can generate a prompt sentence of the form:

“Here is a list of the user's owned items and their degradation states. Propose (1) high-performance latest products to replace items that are heavily worn or close to expiration, (2) products that the user does not own but are typically essential in the same categories, and (3) complementary products that are convenient to use together with the owned items. For each suggestion, provide a short reason.”

The server provides this prompt sentence together with structured inventory data to a generative AI model specialized for language-based recommendation. In one embodiment, this generative AI model is a large language model using a transformer architecture with multiple attention layers, trained on a large corpus of product descriptions and usage scenarios. The model processes the inventory data as serialized text or as embedded vectors and outputs recommendation candidates including proposed product types and associated rationales.

The server uses a recommendation generation module to combine recommendation candidate information from the generative AI model with merchandise management information retrieved from a product catalog database. The server transforms abstract product descriptions into concrete product entries by matching attribute fields, price ranges, and availability. The server generates a merchandise proposal message including product names, brief explanations, and identifiers or links, and the server transmits this message to the terminal via a communication application using a message protocol.

The terminal receives the merchandise proposal message and displays it on the display device using a user interface module. The user can view the recommendations and select entries to obtain additional information. The terminal may present the information as an overlay in a head-mounted display, allowing hands-free operation in a store environment.

The server also processes store product information received from the terminal when the terminal is used in a physical store. The terminal scans products using a camera or a code reader and transmits scanned identifiers and captured images to the server in real time. The server uses an in-store analysis module to combine these inputs with inventory management information such as stock levels and expiration dates. The server generates another prompt sentence for a generative AI model, for example:

“From this shelf image, count the number of visible units of each product, detect empty or partially empty shelf positions, and identify items that appear near expiration or have damaged packaging. Also, suggest which items should be recommended to a current visitor based on freshness and complementarity with common household items.”

The server inputs this prompt sentence and the shelf images to the multimodal generative AI model. The model processes visual features to detect the number of units, locate gaps, and recognize visual signs of damage or near-expiration labels, and uses the textual instructions to format its output. The server then transforms the model output into updated inventory state data and in-store merchandise proposal information. The server distributes this in-store merchandise proposal information to a terminal operated by store staff or a visitor's terminal, enabling real-time decision support for product placement and promotions.

The server and the terminal thus participate in a data processing pipeline that improves computer technology itself. The server reduces communication load by performing preprocessing that downsamples images and extracts only relevant frames before transmitting them to the generative AI model endpoint, and by caching intermediate results. The inventory analysis module uses structured indexes and set-based operations to avoid repeated full scans of the product database, thereby improving computation efficiency. The dynamic generation of prompt sentences allows the server to vary the level of detail and scope of analysis, so that the generative AI model performs only necessary inference, reducing overall processing time and energy consumption.

The server improves accuracy and reduces error by using model architectures and training methods that are tailored to product and inventory data. In one embodiment, the image encoder of the generative AI model is pre-trained on large-scale general image datasets and is then fine-tuned on domain-specific images of products, including different states of packaging and degradation. The text decoder or language model is fine-tuned on corpora of product specifications and inventory descriptions. The training uses supervised learning with labeled data where each image is associated with ground truth labels for product attributes, manufacturing dates, and degradation classes. The model training uses a loss function that is a weighted combination of cross-entropy loss for classification tasks and sequence-to-sequence loss for text generation tasks. The model weights are updated by gradient descent using backpropagation, and training is repeated until convergence criteria based on validation accuracy and loss are satisfied.

The server improves data management by using explicit data models and schemas. The product information data is represented as records with defined fields, and foreign key relationships are enforced between user records, product records, and store records. The server maintains log entries that record when each generative AI model inference was performed and which prompt sentence was used, allowing reproducibility and debugging.

The server can also store anonymized usage patterns to refine prompt generation strategies, such as adjusting threshold values for degradation or selecting category templates.

The terminal contributes to improved technical performance by performing local filtering and batching of captured images. The terminal may compress images using an efficient codec and discard frames that are highly similar, thus reducing the volume of data transmitted to the server. In one embodiment, the terminal performs a lightweight pre-detection of edges or movement to select frames containing significant changes, thereby reducing redundant processing on the server.

The system does not merely automate human visual inspection or manual recommendation.

The server uses the generative AI model and prompt sentences to execute non-conventional processing sequences, such as unified extraction of product attributes, temporal degradation estimation from visual cues, and cross-context recommendation that combines a user's home inventory with real-time store shelf conditions. The server employs internal rules and algorithms that differ from a typical human logic, for example, by combining similarity metrics in a high-dimensional feature space, automatic category template matching, and dynamic weighting of recommendation criteria based on system load and model confidence scores. These operations lead to improvements in precision and recall of product detection and recommendation relevance that cannot be achieved by simple rule-based automation.

The server can implement multiple alternative embodiments and configurations. In one embodiment, the generative AI model is deployed on the same hardware as the server, using an accelerator, and the prompt generation module is tightly integrated with the inference engine. In another embodiment, the generative AI model runs on a separate inference cluster, and the server communicates using a remote procedure call protocol, with batching and queuing mechanisms to optimize throughput. In yet another embodiment, part of the model, such as an image encoder, is deployed on the terminal, and the terminal sends intermediate feature vectors rather than raw images, thereby further reducing communication bandwidth and latency.

The server can also vary the neural network architecture. In one variation, the server uses a vision transformer model with a specific number of layers and heads, and applies positional encoding adapted to product images. In another variation, the server uses a hybrid convolutional and transformer architecture with separate branches for object localization and text understanding. The server may adjust hyperparameters such as learning rate, number of attention heads, and embedding dimensions according to hardware constraints and required inference speed.

The system thus provides an implementation that links concrete hardware components and specific software modules with detailed data structures and algorithms. The server and the terminal carry out a sequence of transformations on image data, text data, and structured records in a way that improves the technical performance of the computer system, achieves accurate and timely extraction of product information, enables dynamic and context-aware use of generative AI models through prompt sentences, and reduces computational and communication overhead compared to conventional systems that do not integrate such mechanisms.

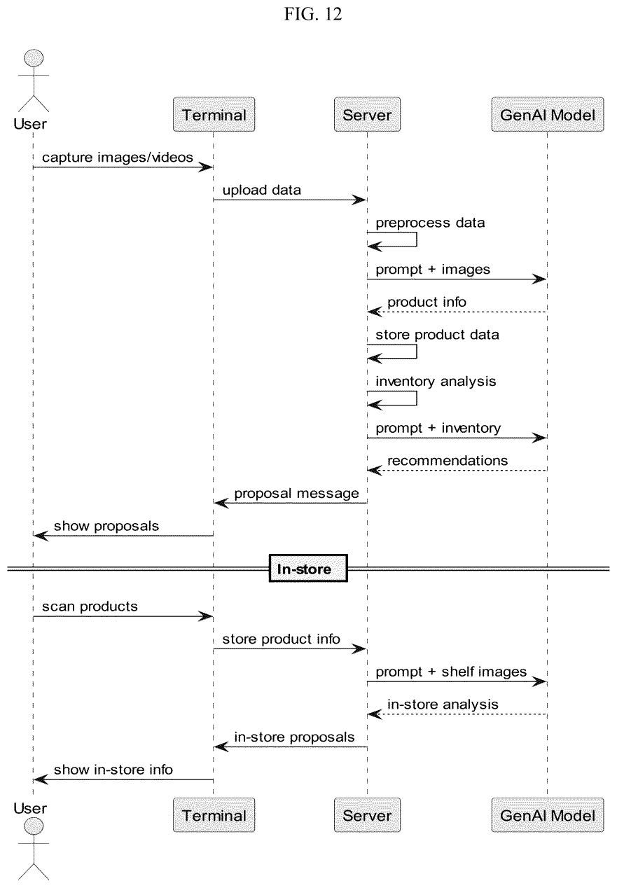

The following describes the processing flow using FIG. 12.

### Step 1:

The user operates the terminal to capture digital information. The user launches an application on the terminal and activates a camera function. The terminal receives raw sensor signals from the image acquisition device, converts the signals into image frames, encodes the frames into image files or video files, and stores the files in local memory together with metadata such as timestamps and approximate location information. The input of this step is a physical scene including products, and the output of this step is digital information including image information or video information stored on the terminal.

### Step 2:

The terminal transmits the captured digital information to the server. The terminal reads the stored image files or video files and constructs a transmission request, including user identification, device information, and capture metadata. The terminal establishes a connection to the server via a communication network and sends the digital information as a data payload using a communication protocol. The input of this step is the locally stored digital information and metadata, and the output of this step is a data packet delivered to the server and received by the server's communication interface.

### Step 3:

The server performs preprocessing on the received digital information. The server receives the data packet and extracts the raw image information or video information and associated metadata. The server decodes the image information into pixel matrices and, if the data is video information, extracts representative frames at specified temporal intervals. The server performs pixel count conversion by resizing images to a target resolution and applies image quality correction such as brightness adjustment, contrast enhancement, and noise reduction using numerical operations on pixel values. The input of this step is the raw digital information from the terminal, and the output of this step is preprocessed visual data represented as normalized pixel matrices stored in memory.

### Step 4:

The server generates a first prompt sentence for product information extraction. The server reads configuration data that specifies analysis requirements, such as identifying product categories, manufacturing dates, and degradation states. The server combines this configuration with context information such as user identity and environment type to construct a natural language instruction. The server generates a prompt sentence, for example: “Given these images of household items, identify each visible product, extract product category, brand, size, and material, read any visible manufacturing or expiration dates on labels, and estimate the degradation state (new, slightly used, heavily worn). Return your findings in a structured textual list that clearly separates each product.” The input of this step is analysis configuration data and context data, and the output of this step is the first prompt sentence stored as a text string.

### Step 5:

The server submits the preprocessed visual data and the first prompt sentence to a generative AI model. The server formats the pixel matrices and the text string into an input structure compatible with a multimodal generative AI model. The server sends this structure to a model inference endpoint over a communication interface. Internally, the generative AI model encodes the images into feature vectors and tokenizes the prompt sentence, processes them through a neural network, and generates output tokens representing detected products and their attributes. The input of this step is the preprocessed visual data and the first prompt sentence, and the output of this step is a textual or semi-structured response describing product attribute information, manufacturing date information, and degradation state information.

### Step 6:

The server converts the generative AI model response into structured product information data. The server parses the model's output text to identify product entries, attribute values, dates, and degradation descriptions. The server maps these elements into a predefined data schema, creating records that include fields such as product category, capacity, manufacturing date, expiration date, and degradation state. The server stores the structured records in a storage device and associates each record with a user identifier and a capture session identifier. The input of this step is the response from the generative AI model, and the output of this step is a set of structured product information records stored in the server's storage.

### Step 7:

The server performs inventory analysis on the stored product information data. The server retrieves all product information records associated with a given user and groups the records by normalized product categories. The server identifies which products are currently owned by the user by aggregating records and resolving duplicates using similarity comparisons between attribute fields. The server determines missing products by comparing the user's owned categories to reference category templates. The input of this step is the stored product information data and reference category templates, and the output of this step is an inventory state that includes a group of products owned by the user, a list of products not owned by the user, and a list of missing products in each category.

### Step 8:

The server generates a second prompt sentence for recommendation candidates. The server reads the inventory state and relevant user preference data and constructs another natural language instruction for the generative AI model. The server generates a prompt sentence, for example: “Here is a list of the user's owned items and their degradation states. Propose (1) high-performance latest products to replace items that are heavily worn or close to expiration, (2) products that the user does not own but are typically essential in the same categories, and (3) complementary products that are convenient to use together with the owned items. For each suggestion, provide a short reason.” The input of this step is the inventory state and user preference data, and the output of this step is the second prompt sentence stored as a text string.

### Step 9:

The server submits the inventory data and the second prompt sentence to a generative AI model for recommendation generation. The server serializes the inventory state into a textual representation or an embedded vector format and combines it with the second prompt sentence in a model input structure. The server sends this structure to a language-based generative AI model. The model processes the inventory description and the prompt sentence to generate recommendation candidates, including product types and rationales. The input of this step is the inventory data and the second prompt sentence, and the output of this step is recommendation candidate information returned as text or structured text.

### Step 10:

The server transforms the recommendation candidate information into concrete merchandise proposals. The server parses the output text to extract candidate product descriptions and reasoning. The server queries a merchandise management database using attribute fields and category information to find available items that match or approximate the candidate descriptions. The server combines product identifiers, prices, stock information, and model-generated reasons into a merchandise proposal structure. The input of this step is the recommendation candidate information and merchandise management information, and the output of this step is a merchandise proposal dataset that lists specific products to be proposed to the user.

### Step 11:

The server generates a merchandise proposal message and transmits it to the terminal. The server formats the merchandise proposal dataset into a message compatible with a communication application, such as a message containing product names, short explanations, and identifiers or links. The server uses a communication interface and a messaging protocol to send the proposal message to the terminal. The input of this step is the merchandise proposal dataset, and the output of this step is a transmitted merchandise proposal message received by the terminal.

### Step 12:

The terminal receives and displays the merchandise proposal message. The terminal's communication client module receives the message from the server and passes it to the user interface module. The terminal decodes the message payload, generates visual elements such as text labels and selectable items, and renders these elements on the display device. The input of this step is the merchandise proposal message from the server, and the output of this step is a visual presentation of proposed products on the terminal for the user to view and interact with.

### Step 13:

The terminal scans products in a physical store and sends store product information to the server. The user or store staff activates a scanning mode on the terminal, and the terminal uses a camera or a code reader to capture images of shelves and to read product codes. The terminal processes the captured data to extract product identifiers, shelf locations, and images and packages these elements into store product information records. The terminal then transmits these records to the server in real time over the communication network. The input of this step is the physical scene of in-store products, and the output of this step is store product information delivered to the server.

### Step 14:

The server analyzes store product information using a generative AI model to produce in-store recommendations. The server receives store product information and retrieves inventory management information for the corresponding store. The server generates a third prompt sentence, for example: “From this shelf image, count the number of visible units of each product, detect empty or partially empty shelf positions, and identify items that appear near expiration or have damaged packaging. Also, suggest which items should be recommended to a current visitor based on freshness and complementarity with common household items.”

The server inputs the shelf images and the third prompt sentence to the multimodal generative AI model. The model outputs counts, degradation assessments, and recommendation suggestions. The server converts these outputs into an in-store inventory state and in-store merchandise proposal information. The input of this step is the store product information, inventory management information, and the third prompt sentence, and the output of this step is in-store merchandise proposal information suitable for presentation to a visitor or store staff.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems in the field of information processing technology typically apply fixed rules or static statistical models to user data, such as purchase history or simple profile attributes. Such systems generally lack a mechanism to dynamically interpret complex ownership situations, degradation states of owned objects, and potential synergies between owned and unowned objects in a flexible, context-aware manner. As a result, these systems often generate generic recommendations that do not sufficiently reflect a user's actual environment, usage period of owned objects, or the usefulness of complementary objects, thereby limiting the effectiveness of automated decision support. Moreover, existing systems that do incorporate machine learning models usually treat the model as a black box operating on coarse-grained features, without programmatically structuring detailed ownership and degradation information into a semantically rich input. In particular, these systems do not construct explicit prompt sentences that encode, in a natural language format, the usage period, replacement candidates, and combination conditions for owned and unowned objects, and do not post-process the resulting natural language output in a way that systematically maps it back to structured proposal objects. Consequently, the computing resources of generative AI models are not efficiently utilized, the quality and granularity of recommendations are inconsistent, and the overall computer functionality for generating personalized proposals remains suboptimal.

Further, conventional architectures often lack an integrated pipeline in which a processor automatically retrieves user-linked data from an information storage device, performs analytical preprocessing to derive replacement candidates and complementary objects, generates a prompt sentence tailored to a generative AI model, and transforms the model's output into structured proposal information that can be automatically delivered to user terminals through a communication application. This absence of an end-to-end, processor-driven workflow leads to increased manual configuration, fragmented processing, higher latency, and reduced scalability.

Accordingly, there is a need for improved computer-implemented techniques that enhance how a processor acquires, analyzes, and represents user ownership information and related states as input to a generative AI model, and how the processor interprets and structures the model's natural language output. Such techniques should improve the efficiency and accuracy of generating proposals of objects, including replacement candidates and complementary unowned objects, and should provide a technically improved mechanism for delivering personalized proposal information through networked communication systems.

The specific processing by the specific processing unit 290 of the data processing device 12 in Example 2 is realized by the following means.

The present invention provides a server comprising a processor configured to acquire, using identification information associated with a user, usage history information and ownership information of the user stored in an information storage device; to generate, on the basis of the usage history information and the ownership information, an analysis result including at least a usage period of owned objects, objects that are candidates for replacement, and objects that are not owned but become useful when used in combination with existing owned objects, and to generate a prompt sentence in a natural language format for input to a generative AI model by formatting the analysis result into natural language; to input the prompt sentence into the generative AI model, to obtain a natural language output regarding proposals of candidate objects based on the analysis result, and to analyze the natural language output to extract a proposal object set including at least high-performance and highly up-to-date objects, objects not owned by the user, and objects whose usefulness is improved when used in combination with existing owned objects; and to generate proposal information for each proposal object included in the proposal object set by adding proposal reason information and acquisition information, and to transmit the proposal information to a terminal via a communication control interface of a communication application. This enables an improved computer-implemented recommendation process in which the server systematically transforms low-level ownership and usage data into a structured natural-language prompt, efficiently leverages a generative AI model to infer context-aware proposals, and converts the model's unstructured output back into machine-usable proposal information that can be automatically delivered to user terminals, thereby enhancing the technical performance, accuracy, and scalability of personalized object proposal generation.

The term “processor” refers to a hardware or virtual information processing unit, such as a central processing unit, a microprocessor, or a virtual machine instance, that executes instructions for implementing functions of the system.

The term “identification information” refers to data that uniquely or semi-uniquely associates data with a particular user, such as a user identifier, an account identifier, or a device identifier.

The term “user” refers to an entity, including a human individual or an organization, that is associated with ownership information and usage history information and that receives proposal information generated by the system.

The term “information storage device” refers to a physical or logical data storage resource, such as a database system, a file storage system, or a memory device, in which usage history information and ownership information are stored.

The term “usage history information” refers to information indicating records of acquisition, utilization, or interaction of the user with objects, including at least acquisition dates, categories, and related attributes of the objects.

The term “ownership information” refers to information indicating objects currently owned by the user, including at least identifiers, categories, acquisition dates, and attributes related to the owned objects.

The term “owned objects” refers to objects, including goods, services, or digital resources, that are indicated as being in the possession or under the control of the user according to the ownership information.

The term “usage period” refers to a duration calculated for an owned object, typically based on a difference between a reference time, such as a current time, and an acquisition time or activation time of the owned object.

The term “objects that are candidates for replacement” refers to objects selected from among the owned objects based on criteria including at least the usage period or a degradation state, and that are suitable for being substituted by other objects.

The term “objects that are not owned” refers to objects that are not indicated as owned in the ownership information of the user and that may be considered as potential proposal targets.

The term “objects that become useful when used in combination with existing owned objects” refers to objects that, when jointly used with one or more owned objects, provide an improvement in functionality, convenience, or performance compared to using the owned objects alone.

The term “analysis result” refers to structured or semi-structured information generated by the processor by processing usage history information and ownership information, the analysis result including at least the usage period, objects that are candidates for replacement, and objects that are not owned but become useful when used in combination with existing owned objects.

The term “prompt sentence” refers to a text sequence expressed in a natural language that encodes the analysis result and instructions in a format suitable for input to a generative AI model.

The term “natural language format” refers to a representation of information using human languages, such as English or other human-readable languages, as opposed to binary or low-level machine code.

The term “generative AI model” refers to a machine-implemented information processing model that receives input including a prompt sentence and generates output content, such as natural-language text, by performing probabilistic or learned transformations based on training data.

The term “natural language output” refers to text generated by the generative AI model in a human language in response to input including the prompt sentence.

The term “proposal object set” refers to a collection of one or more objects identified by the processor on the basis of the natural language output, the collection including at least high-performance and highly up-to-date objects, objects not owned by the user, and objects whose usefulness is improved when used in combination with existing owned objects.

The term “high-performance and highly up-to-date objects” refers to objects that satisfy predetermined criteria relating to performance level and recency, such as technical specifications, release dates, or quality ratings.

The term “proposal information” refers to information generated by the processor for each proposal object, including at least proposal reason information and acquisition information, and formatted for delivery to a terminal.

The term “proposal reason information” refers to information indicating a reason or rationale for recommending a particular proposal object, including factors such as the usage period, degradation state, or combination benefits with owned objects.

The term “acquisition information” refers to information that facilitates acquisition of a proposal object by the user, including at least reference identifiers, access locations, or transaction links.

The term “communication application” refers to an application-level software system that enables message exchange between the server and a terminal, such as a messaging service, a chat service, or a similar communication platform.

The term “communication control interface” refers to an interface, such as an application programming interface or protocol endpoint, provided by the communication application for sending or receiving messages or data.

The term “terminal” refers to an information processing device used by the user to receive proposal information, such as a mobile device, a personal computer, or another network-connected client device.

In one embodiment, a server, a terminal, and a networked communication environment are used to implement the invention. The server includes at least one processor, a main memory, a nonvolatile storage device, and a network interface. The processor is, for example, a general-purpose central processing unit or a set of virtual processing cores provided by a cloud computing platform. The storage device stores a database system such as a relational database management system, and also stores executable programs implementing the functions described below. The terminal is, for example, a smartphone, a tablet computer, or a personal computer that executes a communication application and a web browser. The terminal communicates with the server via a wide area network such as the Internet.

The server stores usage history information and ownership information for a plurality of users in the database system. The server uses, for example, a relational database engine and defines tables for user information, object master information, usage history, ownership records, and recommendation logs. The server arranges the usage history information and ownership information in normalized table structures so that lookups using user identification information can be performed with low latency. The server stores, in the object master table, attributes including at least a category, technical specification indicators, release date, and compatibility relationships with other objects.

The server executes an application program that controls the overall flow of data acquisition, analysis, prompt generation, generative AI model invocation, output parsing, proposal information generation, and communication with the terminal. The server uses a programming language runtime such as a high-level interpreted language runtime or a managed language runtime. The application program is divided into modules including a data-access module, an analysis module, a prompt generator module, a generative-model interface module, a natural-language-output parser module, and a communication module.

Each module communicates via well-defined data structures represented as in-memory objects or records.

The server uses the data-access module to read usage history information and ownership information from the database. The server performs, for example, indexed queries on the usage history table and the ownership table using a user identifier as a key. The server obtains a set of records for owned objects, each record including an object identifier, an acquisition timestamp, a category code, and optional attributes such as usage frequency. The server also obtains a set of candidate objects from the object master table, including attributes that describe whether the object is high-performance and highly up-to-date.

The server uses the analysis module to convert the raw records into an analysis result. The server computes, for each owned object, a usage period by subtracting the acquisition timestamp from a current system time obtained from a system clock. The server compares the usage period with threshold values stored in a configuration table to determine whether the object is a replacement candidate. The server classifies objects into categories, and for each category, the server determines whether the user lacks objects that are typically used in combination with an existing owned object. For this determination, the server uses compatibility relationships stored in the object master table, for example, mapping a display device category to complementary player device categories or accessory device categories.

The server represents the analysis result using an internal data structure that includes, for each owned object, the calculated usage period, a degradation state flag, and identifiers of related candidate replacement objects. The server also includes, in the analysis result, a collection of unowned complementary objects that are likely to increase the usefulness of one or more owned objects if acquired. The server may store this analysis result temporarily in memory or in a cache layer implemented by an in-memory key-value store, in order to re-use the result for multiple prompt generations or multiple calls to a generative AI model.

The server uses the prompt generator module to convert the analysis result into a prompt sentence formatted in natural language. The server prepares template strings that include placeholders for owned object descriptions, usage periods, and missing complementary objects. The server fills these placeholders by inserting values extracted from the analysis result, and the server joins the elements into a coherent natural-language instruction. The server, for example, generates a prompt sentence in the form of a human-readable description plus explicit instructions about the desired type of recommendations to be generated.

In one example, the server generates the following prompt sentence:

“Based on the following user data, identify high-performance and latest products to upgrade, products the user does not own but should consider, and products that are convenient when combined with existing products.

Owned product: television, purchased 2018-03-10, Full HD, 40 inches.

Owned product: soundbar, purchased 2019-07-21.

User does not own: Blu-ray player, streaming device.

Please output a concise recommendation message in natural language.”

In another example, the server generates the following prompt sentence:

“The user's owned-products data indicates that the user has a television that was purchased more than five years ago and does not have a Blu-ray player. Based on this information, generate a personalized recommendation message that proposes a latest 4K television model and a Blu-ray player. Explain briefly why these products are suitable for the user and how using them together will improve the user's movie-watching experience.”

The server transmits the prompt sentence to a generative AI model via the generative-model interface module. The server uses a network communication library to send the prompt sentence to a model execution service over a secure protocol. The generative AI model is implemented, for example, as a multi-layer neural network composed of an embedding layer, multiple transformer layers, and an output layer that predicts token sequences in a target natural language. The model parameters, including weights and biases, are stored in model storage and loaded into an accel erator such as a graphics processing unit or tensor processing unit at inference time.

The server uses the generative-model interface module to encode the prompt sentence as a sequence of tokens, send the tokenized input to the generative AI model, and receive a sequence of output tokens that are decoded back into a natural-language output string. The server may specify decoding parameters such as temperature, top-k, or top-p values to control the diversity and determinism of the generated text. The generative AI model internally applies an attention mechanism over the embedded prompt tokens, computes intermediate activations in the transformer layers, and selects output tokens based on probability distributions defined by the learned parameters.

The server uses the natural-language-output parser module to interpret the natural-language output generated by the generative AI model. The server applies deterministic parsing rules, for example, regular expression patterns or keyword-based segmenters, to detect explicit mentions of object categories, upgrade suggestions, and complement suggestions. The server maps each detected mention to an object identifier or a set of candidate objects in the object master table. To perform this mapping efficiently, the server may precompute an index from normalized category names and feature keywords to object identifiers.

The server generates a proposal object set that includes at least three types of objects: high-performance and highly up-to-date objects, unowned objects suitable for acquisition, and objects that improve usefulness when combined with existing owned objects. The server evaluates each candidate according to technical criteria such as performance scores, release dates, compatibility codes, and availability flags. The server then selects a subset that satisfies constraints stored in the configuration table, such as a maximum number of proposals or a minimum performance threshold.

The server generates proposal information for each proposal object in the proposal object set.

The server composes natural-language explanation text that describes the reason for recommending the object, using templates that incorporate the calculated usage period, the degradation state, and the complementary relationship with owned objects. The server also attaches acquisition information, such as identifiers of sales platforms or deep links to web resources, to enable the user to obtain further information or complete a transaction via the terminal.

The terminal receives the proposal information via a communication application. The terminal executes the communication application to receive messages from the server and to display the content in a user interface. The terminal renders text, links, and optional multimedia elements according to the data sent by the server. The terminal allows the user to scroll through the proposals, select a specific proposal, and invoke a browser application that opens a web page specified by an acquisition link.

The user reviews the proposals on the terminal and may send feedback or preference information back to the server through the communication application. The user can, for example, enter natural-language text indicating a preference for larger screen sizes or a limited budget range. The terminal sends this text to the server, and the server stores it as additional preference information linked to the user. The server can incorporate this preference information into subsequent analysis results and prompt sentences, thus refining future proposals.

In order to achieve an improvement in computer technology rather than a mere automation of human tasks, the server is configured with specific data structures and algorithms that optimize resource usage and increase accuracy. The server uses precomputed usage period thresholds and category-compatibility matrices to reduce the computational cost of identifying replacement candidates and complementary objects. The server also uses incremental updates in the database, caching recent analysis results, and minimizing redundant database queries, thereby improving processing speed and reducing server load.

The server applies deterministic parsing and mapping logic to convert the generative AI model's natural-language output into machine-structured data. By constraining the prompt sentence structure and by using fixed patterns in the output, the server ensures that the parsing process yields predictable fields. This design reduces parsing errors, enhances the reliability of proposal extraction, and enables the server to maintain consistent performance across many users with different data profiles. These technical measures improve the data management and computational efficiency of the recommendation pipeline.

The generative AI model itself is trained in advance using a large corpus that includes product descriptions, technical specifications, and usage scenarios. During training, an optimization algorithm such as stochastic gradient descent or a variant of adaptive gradient methods is used to minimize a loss function such as cross-entropy between predicted and target tokens. The model updates its internal parameters by backpropagating the error through multiple layers of the network. The training process incorporates techniques such as dropout, layer normalization, and positional encoding to stabilize and enhance the learning. As a result, the generative AI model acquires the capability to interpret complex prompt sentences and to generate context-aware natural-language outputs that are sensitive to usage period, degradation, and complementary relationships.

The server uses this generative AI capability in a non-conventional way by constructing prompt sentences that encode detailed, computed technical states of the owned objects, rather than simple user preferences or categories. The server thereby offloads complex contextual reasoning to the generative AI model while retaining deterministic control over data acquisition and result parsing. This hybrid design, where deterministic modules and a generative AI model cooperate through structured prompt sentences, contributes to improved accuracy and technical performance over conventional rule-based or static-model systems.

The system can be implemented in alternative configurations. In one variant, the generative AI model is hosted on the same physical server that stores the database. In another variant, the generative AI model runs on a separate accelerator cluster, and the server communicates with the cluster via a dedicated network segment. In yet another variant, the terminal executes a lightweight local inference model that refines or post-processes the proposals received from the server based on device-specific constraints such as display capability or local storage capacity.

The server can implement additional optimization mechanisms. For example, the server can perform batch processing of prompt sentences for multiple users and send them as a batch to the generative AI model, thereby reducing communication overhead and improving throughput. The server can also maintain a history of prompt sentences and outputs, and use this history to detect redundant requests or to construct incremental prompts that reference previous model outputs, thus reducing token count and lowering processing costs.

The technical effect of these configurations is that the server transforms the entire chain of data from raw usage history and ownership records through analysis and generative modeling into actionable, structured proposal information in a way that improves processing speed, recommendation precision, and communication efficiency. The system reduces redundant network calls, reduces database load by using structured indices and caches, and reduces parsing ambiguity by using constrained natural-language formats. This combination of steps produces a concrete improvement in the functioning of the computer system as a whole, rather than merely automating manual selection of products.

In summary, the server, the terminal, and the associated modules implement a specific arrangement of data structures, algorithms, and model interactions that enable a generative AI model to be used as part of an efficient, technically improved recommendation pipeline. The use of structured prompt sentences, analysis-driven encoding of technical object states, and deterministic post-processing of model outputs allows the system to achieve advantages in speed, accuracy, and scalability that are not obtainable by conventional recommendation systems or by simple automation of human decision-making.

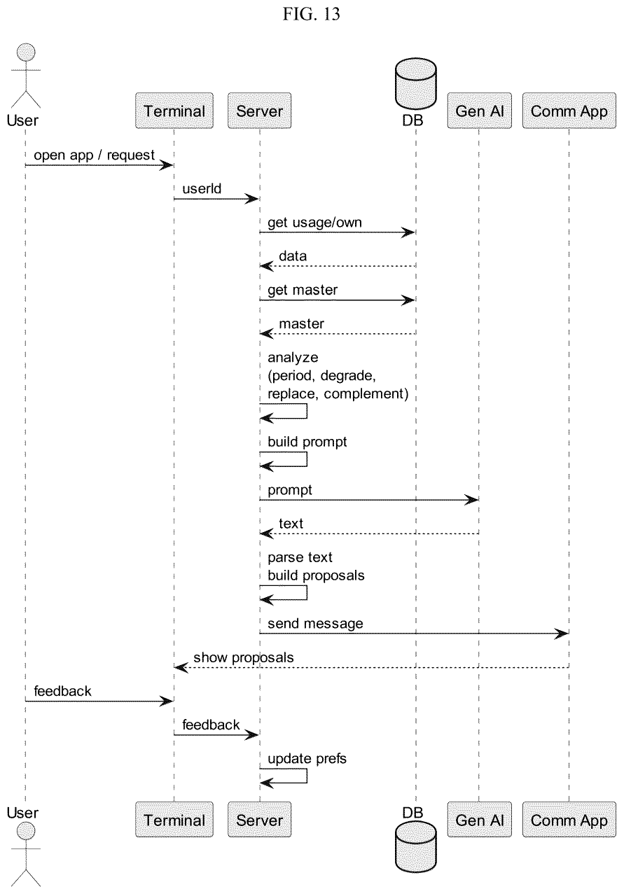

The following describes the processing flow using FIG. 13.

### Step 1:

Server receives a request associated with a user.

Server uses a user identifier included in the request as input.

Server validates the user identifier format, checks authentication or session information if available, and converts the identifier into an internal representation.

Server outputs a normalized user identifier that is used in subsequent database operations.

### Step 2:

Server acquires usage history information and ownership information from a database using the normalized user identifier as input.

Server sends parameterized queries to a relational database engine to retrieve rows from a usage history table and an ownership table.

Server performs data processing that includes joining tables, filtering by the user identifier, and selecting fields such as object identifiers, acquisition timestamps, categories, and attributes.

Server outputs a set of in-memory records representing the user's owned objects and past acquisitions in a structured format such as lists of records or key-value maps.

### Step 3:

Server acquires candidate object information and compatibility information from an object master table using the categories contained in the ownership information as input.

Server queries the database for objects marked as high-performance, recently released, or compatible with the categories of owned objects.

Server performs data processing that includes category-based indexing, filtering on performance and recency flags, and retrieving compatibility relationships that map one category to another.

Server outputs candidate object records and a compatibility matrix that indicates complementary relationships between objects and categories.

### Step 4:

Server computes usage periods and degradation states for each owned object using the acquisition timestamps and a system time as input.

Server applies a time difference calculation between the current time and each acquisition timestamp, and then compares the result with threshold values stored in configuration data.

Server performs data computation that labels each object with a usage period value and a boolean or multi-level degradation state flag (for example, “normal,” “aging,” or “obsolete”).

Server outputs enriched ownership records in which each object has additional fields representing usage period and degradation state.

### Step 5:

Server identifies replacement candidates and complementary unowned objects using the enriched ownership records and the compatibility matrix as input.

Server examines each owned object to determine whether its degradation state satisfies conditions for replacement, such as exceeding a usage period threshold or being marked as obsolete.

Server applies compatibility rules to determine which unowned objects can increase the usefulness of specific owned objects when used together, based on category relationships and attribute matching.

Server outputs an analysis result that includes lists of replacement candidate objects, lists of complementary unowned objects, and a summary of technical states for the owned objects.

### Step 6:

Server constructs a prompt sentence using the analysis result as input.

Server selects template strings that describe the user's owned objects, usage periods, degradation states, and missing complementary objects, and then fills in placeholders with actual values from the analysis result.

Server performs text processing that concatenates template segments, inserts natural-language connectors, and ensures that instructions to the generative AI model are explicit and unambiguous.

Server outputs a complete prompt sentence in natural language that encodes the analysis result and requested recommendation behavior.

### Step 7:

Server sends the prompt sentence to a generative AI model and receives a natural-language output.

Server uses the prompt sentence as input to a model interface module, which tokenizes the text, applies model-specific encoding, and transmits the encoded sequence to the generative AI model over a network.

Server receives an output token sequence from the model, decodes the tokens into a natural-language string, and may apply basic cleanup operations such as trimming whitespace or normalizing punctuation.

Server outputs a natural-language output text that describes recommended objects, reasons, and possible combinations.

### Step 8:

Server parses the natural-language output using the natural-language output text and the object master data as input.

Server applies deterministic parsing rules, including pattern matching and keyword extraction, to detect mentions of object types, performance attributes, and complementary relationships.

Server uses the detected textual mentions to search the object master data, matching category names, technical feature words, or normalized labels to actual object identifiers.

Server outputs a proposal object set that contains structured entries for each proposed object, including mapped object identifiers and extracted rationale phrases.

### Step 9:

Server generates proposal information using the proposal object set as input.

Server composes explanation text for each proposal object by inserting object names, usage period information, and complementary benefits into explanation templates.

Server attaches acquisition information, such as references to sales endpoints or information pages, to each proposal object based on the object identifiers.

Server outputs a structured proposal information package that includes, for each object, an explanation, technical justification, and acquisition data.

### Step 10:

Server formats a message for a communication application using the proposal information package as input.

Server converts the proposal information into a message body suitable for display on the terminal, for example by creating bullet lists, short paragraphs, and clickable links.

Server constructs a message payload in accordance with the communication application's protocol specification, including the user's communication identifier and the formatted message body.

Server outputs a message payload ready to be transmitted to the communication application.

### Step 11:

Server sends the message payload to the communication application and receives a delivery status.

Server uses the message payload as input to a communication control interface, such as an application programming interface endpoint, and transmits the payload over a network connection.

Server processes the response from the communication application, checking status codes or result fields to confirm that the message has been accepted or delivered.

Server outputs a delivery status record that may be stored in a log table or monitoring system.

### Step 12:

Terminal receives the proposal message using the communication application as input.

Terminal decodes the message payload according to the communication application's protocol, extracts the message body, and renders the content in a user interface area such as a chat window.

Terminal performs display operations, including line wrapping, hyperlink rendering, and scrollable layout, so that all proposal items and associated acquisition information are visible to the user.

Terminal outputs a visual representation of the proposals and, optionally, user interaction events such as link selections.

### Step 13:

User reviews the proposals on the terminal and optionally provides feedback using the displayed message as input.

User reads the explanation text, evaluates the suggested replacement and complementary objects, and may tap a link to open a browser for more detailed information.

User enters text feedback or preference constraints, such as “I prefer a larger screen” or “I have a limited budget,” and sends this feedback through the communication application.

User outputs user-generated preference information that is transmitted by the terminal to the server.

### Step 14:

Server updates user preference data using the received feedback as input.

Server parses the feedback text to detect preference keywords, such as size, budget, or brand-neutral conditions, and associates these preferences with the user identifier in a preference table.

Server merges the newly stored preferences into the user profile, updating or augmenting fields that affect future analysis, such as preferred categories, maximum price ranges, or minimum specifications.

Server outputs an updated user profile that can be used as additional input for subsequent executions of Steps 2 through 9, thereby refining later prompt sentences and recommendation results.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional product recommendation systems typically rely on static rules or narrow machine learning models that operate on limited, siloed input data such as purchase history or coarse category information. These systems suffer from several technical deficiencies in terms of computer technology.

First, conventional systems do not effectively exploit rich, high-dimensional visual data captured by user devices. Raw image and video streams from cameras are often processed only for simple object recognition, if at all, and are not transformed into structured, machine-interpretable inventories including feature descriptors, type classification, location, and deterioration information. As a result, computing resources are not used efficiently to extract actionable, fine-grained device-side context from visual data.

Second, conventional systems treat natural language generative models, if used at all, as generic text generators driven by ad-hoc prompts manually composed by application logic.

The prompt design is typically static and loosely coupled to upstream perception, user modeling, and downstream ranking. This leads to unstable model output, requires extensive manual tuning by developers, and limits the ability of the system to automatically adapt to different users, device environments, and emotional contexts. From the perspective of computer technology, the lack of a systematic, machine-generated prompt construction pipeline wastes computational potential of the generative AI model and increases overall system latency and error rates.

Third, existing architectures are generally not configured to integrate multiple heterogeneous signals-visual object information, historical user behavior information, and emotional state information-into a unified representation that can be consumed by a generative AI model and downstream ranking logic. Visual processing modules, user-profiling modules, and emotion-analysis modules often operate in isolation, producing outputs that are not normalized or orchestrated. This causes duplication of computation, inconsistent feature usage, and degraded performance in recommendation quality and responsiveness.

Fourth, current systems rarely implement a closed-loop mechanism in which user selection operations, purchases, and explicit evaluations are systematically logged and used to update both the prompt construction rules and the cooperation between recommendation algorithms and generative AI models. In many products, feedback is either discarded or used only to adjust simple weights in a scoring function. This results in a static and brittle system that cannot efficiently self-optimize in view of evolving user behavior, changing device contexts, or updated generative models. From a computer-technical perspective, this yields sub-optimal use of storage, processing, and model inference resources, and prevents dynamic adaptation of the end-to-end pipeline.

Accordingly, there is a need for a computer-implemented system and server architecture that: (i) automatically converts multimodal user input, including visual and audio information, into structured article information, user profile information, and emotion information; (ii) dynamically constructs prompt sentences for a generative AI model based on these structured data; (iii) generates and ranks product candidates in an emotion-adaptive and context-aware manner; and (iv) uses logged interaction and feedback information to update the prompt-construction rules and recommendation algorithms. Such a system should improve the technical behavior of the overall computing environment by reducing manual configuration effort, stabilizing generative model outputs, enabling more efficient use of processing resources, and providing higher fidelity between sensed user context and generated recommendations.

The specific processing by the specific processing unit 290 of the data processing device 12 in Application Example 2 is realized by the following means.

The present invention provides a server comprising a processor configured to receive visual information and audio information acquired by a user using an information processing terminal having an imaging function, to execute an image processing unit to perform preprocessing on the visual information, to determine presence or absence of an article in the visual information, and to extract article information including feature information, type information, and placement position information for each article; to obtain the extracted article information together with user behavior information including past purchase history information, viewing history information, and owned-object information, to analyze the user behavior information by using a statistical processing unit and a machine learning unit, and to generate a user profile including preference information, lifestyle information, and budget tendency information; to estimate an emotional state of the user by using an emotion analysis unit based on at least one of the audio information and text information and based on the visual information, and to generate emotion information including an emotion type and intensity information representing the emotional state; to dynamically construct a prompt sentence, which is an instruction sentence to be input to a generative AI model, based on the article information, the user profile, and the emotion information, to input the prompt sentence to the generative AI model, and to cause the generative AI model to specify product information, manufacturing information, and deterioration information corresponding to the articles included in the visual information; to generate product candidate information by identifying, based on a response from the generative AI model, products not owned by the user, by classifying the products not owned into replacement products, additional products, and newly proposed products based on the article information and the user profile, and by assigning relevance information to each product; to generate an emotion-adaptive product proposal list by determining a presentation order and presentation priority of product candidates based on the product candidate information and the emotion information so as to amplify or alleviate the emotional state of the user; to transmit the product proposal list to the information processing terminal via a notification service or a communication application so as to cause the information processing terminal to display the product proposal list; and to accumulate feedback information including user selection operation information, purchase information, and evaluation information acquired from the information processing terminal, and, based on the feedback information, to update rules for constructing the prompt sentence and to update a recommendation algorithm cooperating with the generative AI model so as to improve accuracy of subsequent product proposals. This enables an improved computer-implemented recommendation pipeline that automatically transforms multimodal user input into structured representations, generates context-specific prompt sentences for the generative AI model, adaptively ranks product candidates in accordance with user emotion and profile, and continuously refines the end-to-end behavior of the server through feedback, thereby enhancing stability, efficiency, and personalization of AI-driven product proposals.

The term “processor” refers to a hardware information-processing unit, or a combination of hardware units, configured to execute computer-readable instructions to perform the functions described in the present specification.

The term “visual information” refers to image data or video data acquired by an imaging function of an information processing terminal, including still images, moving images, and any associated metadata.

The term “audio information” refers to acoustic data acquired by a sound-capturing function of an information processing terminal, including voice signals, environmental sounds, and any encoded representation thereof.

The term “information processing terminal” refers to an end-user computing device having at least an imaging function and a communication function, such as a portable terminal, a stationary terminal, or another electronic device capable of capturing, storing, and transmitting digital data.

The term “imaging function” refers to a capability of an information processing terminal to capture visual information by means of an optical sensor or an equivalent image-acquisition component.

The term “image processing unit” refers to a software component or a hardware-implemented module configured to perform image-processing operations on visual information, including at least one of resizing, denoising, normalization, color conversion, and object detection.

The term “article” refers to a physical object present in a scene represented by visual information, including consumer goods, household items, electronic devices, apparel, or other tangible items that can be recognized and analyzed by the system.

The term “article information” refers to structured data associated with an article detected in visual information, including feature information, type information, placement position information, and optionally deterioration information and identification information.

The term “feature information” refers to numerical or symbolic descriptors representing visual or contextual characteristics of an article, such as shape features, color features, texture features, or other properties extracted by a feature-extraction process.

The term “type information” refers to classification data indicating a category or class of an article, such as a functional category, a product category, or another taxonomical designation.

The term “placement position information” refers to data indicating a location of an article within visual information, including at least one of image coordinates, bounding-box coordinates, or region identifiers.

The term “user behavior information” refers to historical data related to interactions of a user with products or services, including past purchase history information, viewing history information, owned-object information, and other usage logs.

The term “past purchase history information” refers to data records describing transactions in which the user has acquired products or services, including identifiers, categories, timestamps, and associated attributes.

The term “viewing history information” refers to data indicating items or content that the user has browsed, viewed, or otherwise inspected via an information processing terminal or another interface.

The term “owned-object information” refers to data describing products or articles that the user currently owns, including identifiers, categories, acquisition times, and optionally condition information.

The term “statistical processing unit” refers to a software component or hardware module configured to perform statistical analysis on input data, including aggregation, normalization, correlation, or other statistical computations.

The term “machine learning unit” refers to a software component or hardware-implemented module configured to execute machine-learning algorithms, including classification, regression, clustering, or representation-learning algorithms, on input data.

The term “user profile” refers to structured information representing inferred characteristics of a user, including preference information, lifestyle information, budget tendency information, and other attributes derived from user behavior information.

The term “preference information” refers to data describing tendencies of a user to favor specific categories, styles, attributes, or characteristics of products or services.

The term “lifestyle information” refers to data describing patterns of behavior, activities, and usage contexts of a user, inferred from user behavior information and optionally from external data.

The term “budget tendency information” refers to data indicating typical spending ranges or price sensitivities of a user in one or more product categories.

The term “emotion analysis unit” refers to a software component or hardware-implemented module configured to analyze at least one of audio information, text information, and visual information to estimate an emotional state of a user.

The term “emotional state” refers to a psychological or affective condition of a user at a point in time, such as joy, sadness, neutrality, or other emotional categories.

The term “emotion information” refers to structured data representing an emotional state of a user, including at least an emotion type and intensity information.

The term “emotion type” refers to a categorical label assigned to an estimated emotional state, such as a label representing a positive, negative, or neutral emotion, or a more specific emotional category.

The term “intensity information” refers to data indicating a degree, magnitude, or confidence level associated with an estimated emotional state.

The term “prompt sentence” refers to a natural-language or structured instruction sentence that is generated by the processor and input to a generative AI model to specify a processing task, a context, and a desired output format.

The term “generative AI model” refers to a machine-learning model trained to generate output data, such as natural-language text, based on input data including prompt sentences and contextual information.

The term “product information” refers to structured data describing a product, including at least a product type, category, or specification information.

The term “manufacturing information” refers to data relating to production of a product, including at least a manufacturing time, manufacturing location, or production-related attributes.

The term “deterioration information” refers to data indicating a state of degradation, wear, or aging of an article or product, represented by qualitative labels, quantitative scores, or both.

The term “product candidate information” refers to structured data representing one or more candidate products proposed by the system, including product identifiers, classification as replacement, additional, or newly proposed products, and relevance information.

The term “replacement product” refers to a candidate product that is proposed to functionally or qualitatively replace an existing article owned by the user.

The term “additional product” refers to a candidate product that is proposed to complement an existing article owned by the user without replacing it.

The term “newly proposed product” refers to a candidate product that the user does not currently own and that is proposed as a new item based on inferred user interests or gaps in owned-object composition.

The term “relevance information” refers to one or more values indicating a degree of suitability or importance of a candidate product for the user, based on article information, user profile, and optionally emotion information.

The term “emotion-adaptive product proposal list” refers to an ordered collection of candidate products whose presentation order and priority are determined based on product candidate information and emotion information so as to amplify or alleviate an emotional state of the user.

The term “notification service” refers to a communication infrastructure that delivers data from a server to an information processing terminal, including push-notification services and equivalent messaging mechanisms.

The term “communication application” refers to an application program executed on an information processing terminal that enables exchange of messages or data between the terminal and a server or another device.

The term “feedback information” refers to data collected from an information processing terminal that describes reactions of a user to presented products or lists, including at least selection operation information, purchase information, and evaluation information.

The term “selection operation information” refers to data describing user interactions such as clicks, taps, or selections applied to elements representing products or proposals in a user interface.

The term “purchase information” refers to data indicating a transaction in which a user acquires a product that has been proposed by the system, including identifiers, quantities, and transaction attributes.

The term “evaluation information” refers to explicit feedback provided by a user regarding proposed products or lists, such as ratings, textual comments, or categorical evaluations.

The term “rules for constructing the prompt sentence” refers to parameterized procedures, templates, or algorithms executed by the processor to generate prompt sentences from article information, user profile information, emotion information, and other contextual data.

The term “recommendation algorithm cooperating with the generative AI model” refers to a computational procedure that uses outputs of the generative AI model, together with structured data about the user and articles, to compute product candidate information, ranking scores, and final product proposal lists.

The term “product proposal list” refers to a structured representation, including an ordered set of one or more candidate products and associated metadata, that is generated by the processor and transmitted to an information processing terminal for presentation to a user.

In one embodiment, a server, a plurality of terminals, and a network form a recommendation system configured to generate context-aware, emotion-adaptive product proposals by using a generative AI model driven by dynamically constructed prompt sentences.

### A. Overall Hardware and Software Configuration

Server uses one or more general-purpose computing devices equipped with at least one multi-core CPU, a memory subsystem, a non-volatile storage device, and, in some embodiments, one or more graphics processing units (GPUs). Server executes an operating system and a set of application programs including:
an image processing module implemented with an image-processing library such as an open-source computer-vision library,
a machine-learning module implemented with a framework such as a tensor-based deep-learning framework,
a data-analysis module implemented with a numerical-analysis library and a data-frame library,
an emotion-analysis module implemented with a neural-network-based classifier or an external emotion-recognition service, and
a generative AI interface module configured to communicate with a generative AI model, which may be hosted on the same hardware or on a remote inference service.

Terminal uses a portable or stationary information processing device such as a smartphone, a tablet, or a personal computer. Terminal comprises:
an imaging component such as a camera sensor capable of acquiring still images and videos,
an audio acquisition component such as a microphone,
a display component,
a network interface for wireless or wired communication, and
an application program providing a user interface and communication with server.

User operates terminal to capture visual information and audio information in a real-world environment, such as a room or a storage space in which physical articles are placed.

### B. Data Structures and Internal Representations

Server uses explicit data structures to achieve technical improvements in processing speed and accuracy. Server stores captured images and videos in a frame store, where each frame is associated with a unique frame identifier and metadata including a timestamp, camera parameters, and resolution.

Server represents detected articles by an article record. The article record includes:
an article identifier,
a type label (for example, “display device”, “audio device”, “furniture”, “garment”),
a feature vector, being a numerical vector of fixed dimension (for example, 512 elements) extracted by a convolutional neural network,
placement position information including bounding-box coordinates normalized to the frame,
an estimated deterioration score represented as a normalized scalar value,
an optional catalog link to a product entry in a product database.

Server stores user behavior information in a user profile store, where each user is associated with:
a purchase history table,
a viewing history table,
an owned-object table, and
a derived profile record including preference information, lifestyle information, and budget tendency information.

Server represents emotion information by an emotion record including:
an emotion type label (for example, “joy”, “sadness”, “neutral”),
an intensity score,
a confidence score, and
a timestamp.

Server represents product recommendation candidates in a candidate table, where each candidate product includes:
a candidate identifier,
a classification flag indicating replacement product, additional product, or newly proposed product,
a relevance score,
an emotion-adjusted priority score.

By using these explicit data structures, server avoids repeated parsing of unstructured data and reduces computational overhead when performing subsequent ranking and filtering, thereby improving processing speed and scalability.

### C. Article Extraction and Deterioration Estimation

Server uses the image processing module to perform image normalization and object detection. Server applies a convolutional neural network (CNN)-based detector, for example a single-shot or region-based detector, trained on a dataset of household scenes. Server uses specific architecture choices such as stacked convolutional layers with rectified linear activation, batch normalization layers, and max-pooling layers. Server applies anchor boxes and non-maximum suppression to produce a limited set of bounding boxes with class labels and confidence scores.

Server converts each cropped article image into a feature vector by using a feature-extraction neural network. The feature-extraction network may be a residual network in which residual blocks are formed by convolutional layers and skip connections. Server uses the activations of an intermediate layer as a fixed-length feature vector. These feature vectors enable efficient k-nearest neighbor search in a vector index, which reduces latency compared to text-based search.

Server estimates deterioration information by applying a regression head or classification head on top of the feature-extraction network. Server trains this head to output an estimated deterioration score, using training data labeled with condition categories. Server uses a loss function such as mean squared error for regression or cross-entropy for classification. Server updates the network weights during training with gradient-descent-based optimization, thereby allowing the system to distinguish subtle visual patterns of wear or aging more accurately than rule-based methods.

Because server executes all these neural-network operations in a batched manner on GPU hardware, server achieves higher throughput for frames per second and lower average latency for feature extraction and deterioration estimation than a naïve per-object CPU-only approach. This constitutes a technical improvement in image-processing efficiency.

### D. User Behavior Analysis and Profile Generation

Server uses the data-analysis module to transform user behavior information into a structured user profile. Server loads purchase history, viewing history, and owned-object information into a data-frame structure. Server normalizes category labels, encodes categorical variables with numerical identifiers, and computes features such as purchase frequency, recency, and price range statistics.

Server then uses the machine-learning module to perform clustering and classification. Server may use algorithms such as k-means clustering or Gaussian mixture models to group users with similar behavior. Server also trains a feed-forward neural network to predict preference intensities for product categories based on historical behavior vectors. The network is trained using a supervised objective that minimizes error between predicted and observed future purchases.

By maintaining this learned mapping from sparse behavioral logs to dense preference vectors, server can infer preference information, lifestyle information, and budget tendencies more accurately than hand-crafted rule systems. This leads to a technically improved method for compressing large-scale behavior logs into small, reusable profile vectors, which reduces memory usage and allows faster retrieval.

### E. Emotion Analysis and Integration

Server uses the emotion-analysis module to estimate a user's emotional state from audio information and, in some embodiments, from facial images. Server first applies a pre-processing stage in which server converts audio waveforms into spectrograms or mel-frequency cepstral coefficient (MFCC) feature sequences. Server normalizes these sequences and uses them as input to a recurrent or temporal convolutional neural network for emotion classification. The network outputs probabilities over emotion classes, which server converts into an emotion type and intensity score.

Server optionally uses a separate CNN-based facial emotion recognition model on visual information containing a user's face. Server fuses audio-based and image-based predictions by computing a weighted average of probability distributions or by feeding concatenated intermediate features into a fusion network.

This multi-modal fusion architecture is not a mere automation of human judgment; it leverages numerical representations and transformation functions unavailable to human observers. By exploiting cross-modal consistency and training on large datasets, the system can detect subtle emotional cues, thereby improving the accuracy and stability of the emotion record. The emotion record is then used as a control signal in downstream ranking logic, which changes the internal behavior of the server relative to a system that does not integrate emotion.

### F. Dynamic Construction of Prompt Sentences for the Generative AI Model

Server implements a non-conventional pipeline for constructing prompt sentences. Rather than using static, manually written prompts, server uses the structured article information, user profile, and emotion information to dynamically generate a prompt sentence that is specialized to the current context.

Server uses a template grammar and a rule engine. The template grammar includes segments for:
inventory description, into which server inserts summarized article information,
user context description, into which server inserts key profile features, and
emotion description, into which server inserts the emotion type and intensity.

Server applies rules that determine which segments are included or omitted, how much detail is inserted, and what constraints are provided to the generative AI model. These rules depend on factors such as:
number of detected articles,
range of deterioration scores,
variability of user preferences, and
stability of emotion estimates.

For example, server generates a prompt sentence such as:

“You are a recommendation engine. Here is the user's current inventory: [list of articles with types, estimated manufacturing dates, and deterioration scores]. Here is the user's profile: [summary of hobbies, style preferences, and budget range]. Here is the current emotion state: [joy with high intensity]. Based on this information, list: (1) high-performance latest products that could replace deteriorated items, (2) useful products the user does not currently own, and (3) products that work well in combination with existing items. For each product, provide a brief explanation.”

In another context where the user's behavior indicates a specific hobby, server generates a prompt sentence such as:

“The user's hobby is golf, the current emotion is joy, and the user owns mid-range golf clubs purchased five years ago. Propose 5 golf-related products that will delight the user, including at least one high-end upgrade and one new accessory the user does not own. Provide concise reasons for each choice.”

By algorithmically generating prompt sentences in this manner, server tightly couples upstream feature extraction and profile inference with downstream generative inference. This reduces variance in the generative AI output, lowers the need for manual prompt engineering, and constitutes a technical improvement in the way the generative AI model is controlled.

### G. Generative AI Model Interaction and Candidate Generation

Server uses a generative AI model such as a large-scale transformer network trained for conditional text generation. The model receives the prompt sentence as a sequence of token identifiers. The model comprises an embedding layer, multiple self-attention layers, and feed-forward layers. The model parameters have been optimized on a corpus of text data using autoregressive training with a cross-entropy loss function. During inference, server sets generation parameters such as a maximum token length, temperature, and nucleus sampling threshold.

Server passes the context-rich prompt sentence to the generative AI model through the generative AI interface module. The model outputs a token sequence, which server decodes into text. Server then uses a structured extraction routine to identify product names, categories, and explanations from the generated text. Server maps these textual descriptions to records in the product database by computing similarity between the generated description vector and pre-computed product embedding vectors.

Server assigns each candidate product a relevance score that depends on:
similarity between generated description and catalog entry,
match between product category and user preference vector,
suitability as a replacement based on deterioration scores, and
degree of novelty relative to the owned-object table.

The combination of generative text with structured post-processing allows the system to explore a larger candidate space than a pure catalog-based recommender while maintaining control via relevance and content filtering. This hybrid architecture provides improved recall and diversity at comparable or lower latency than sequential rule-based queries.

### H. Emotion-Adaptive Ranking and Technical Effect

Server uses the emotion record as an input to ranking logic. Server computes an emotion-adjusted priority score for each candidate product by applying a function f that combines relevance score and emotion alignment. For instance, server increases the score of “celebratory” items when the emotion type is joy and intensity is high, and increases the score of “comfort” or “soothing” items when the emotion type indicates stress or sadness.

Server implements emotion alignment via a learned or hand-coded mapping from product attributes to emotional effects. Server may train a separate model that predicts user satisfaction scores given emotion state and product category. By using this control signal, server changes the execution path of the ranking algorithm and the order of items sent to terminal. This is not a mere display choice, but a modification of internal data structures and sorting keys that affects caching, bandwidth usage, and timing.

Because server sends only the highest-priority subset of candidates to terminal, communication load is reduced. By aligning candidates with emotion, server reduces the number of user interactions required to find desirable items, thus decreasing overall network usage over multiple sessions. These aspects yield concrete improvements in communication efficiency and resource utilization.

### I. Feedback Collection and Closed-Loop Optimization

Terminal displays the product proposal list as interactive elements. User selects items, requests details, purchases items, or dismisses suggestions. Terminal records these interactions and sends feedback information back to server, including selection operation information, purchase information, and evaluation information such as ratings.

Server logs feedback information together with identifiers for:
the prompt sentence used,
the generative AI model response,
the article records and user profile used as inputs.

Server periodically executes an update process. Server uses logged feedback to:
retrain ranking models that compute relevance scores,
adjust weight parameters used in emotion-adaptive ranking,
refine or prune prompt templates and construction rules.

Server may, for example, learn that certain prompt patterns produce recommendations with consistently higher acceptance rates and adjust its template selection policy accordingly.

Server may also update thresholds for deterioration scores that trigger replacement suggestions.

By performing this closed-loop optimization automatically, server continually improves the accuracy and efficiency of the recommendation pipeline. Because the optimization affects internal model parameters and control logic within the server, the system improves itself at the level of computer technology rather than only at the business-process level.

### J. Example Use Case and Technical Advantages

User uses terminal to capture images of a living room containing an older display device and audio device. Terminal transmits the data to server. Server detects the devices, estimates high deterioration scores for both, and identifies them as candidates for replacement. Server's user profile analysis indicates that user prefers mid-range prices and cinematic experiences.

Emotion analysis of user's excited voice indicates joy with high intensity.

Server constructs a prompt sentence that explicitly mentions aging display equipment, user's preference for cinematic content, and joyful mood. Generative AI model returns several candidate display and audio products designed for cinematic experiences, along with accessory suggestions. Server maps these to catalog entries, scores them, and adjusts ordering to prioritize celebratory upgrades.

Terminal receives a compact list of top candidates and displays them. Because the list is highly relevant and emotionally aligned, user quickly selects one item without browsing many irrelevant options. Thus, server reduces round-trip interactions and transfers fewer data records over the network.

In contrast to conventional systems that rely on static rules or manually written recommendation text, this embodiment uses deeply integrated feature extraction, learned user modeling, emotion-adaptive ranking, and dynamic prompt generation. These technical mechanisms collectively reduce processing time for candidate generation, improve precision and recall of recommendations, lower communication load, and stabilize generative model behavior. As a result, the invention improves the functioning of the computer-implemented recommendation system itself, not merely the efficiency of a human or business workflow.

### K. Variations and Alternative Embodiments

Server may use alternative neural-network architectures for object detection, feature extraction, user-preference modeling, and emotion analysis, such as transformer-based models or graph-based networks. Server may change the dimensionality of feature vectors or use alternative similarity search structures such as tree-based indices or hash-based indices.

Server may host the generative AI model locally or access it as a remote service. In some embodiments, server caches generative AI outputs for commonly occurring contexts and refines them using post-processing rules, thereby further reducing inference latency.

Terminal may be a head-mounted display device or an in-vehicle infotainment system, and the same processing pipeline applies to captured visual and audio information in those environments. Server may combine sensor data such as location or time information with the article information and user profile when constructing prompt sentences, thereby generating context-specific recommendations relevant to particular locations or time ranges.

In all these embodiments, server, terminal, and user cooperate in a manner consistent with the claims, while the underlying technical principles-structured extraction of article information, learned user profiling, multi-modal emotion analysis, dynamic prompt sentence generation for a generative AI model, emotion-adaptive ranking, and feedback-driven optimization remain the same and continue to produce the technical effects described above.

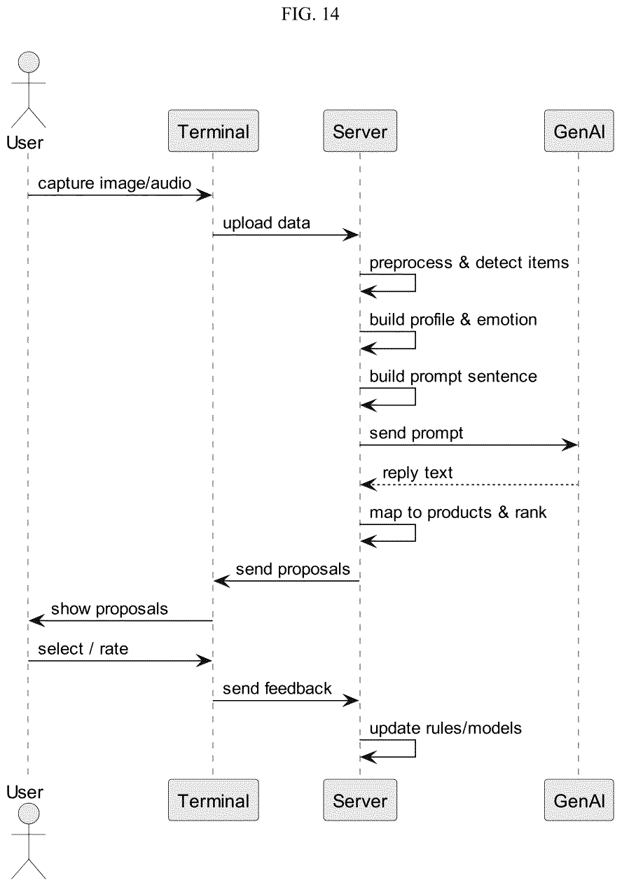

The following describes the processing flow using FIG. 14.

### Step 1:

User operates terminal to capture visual and audio data.

User points the imaging component of terminal toward a room or storage space and triggers an image or video capture function.

Terminal acquires visual information (for example, JPEG images or MP4 video frames) and audio information (for example, WAV or AAC files) and stores them in local storage together with timestamps and device metadata.

Input: real-world scene containing physical articles and, optionally, user speech.

Output: digital visual information and audio information files stored on terminal with associated metadata.

### Step 2:

Terminal prepares and transmits captured data to server.

Terminal collects paths of the stored visual and audio files, encapsulates them in an HTTP request payload, and attaches user identification data and device identification data.

Terminal compresses large files if necessary and sends the payload to a predefined server endpoint over a secure network connection.

Input: digital visual information files, audio information files, user ID, and device ID stored on terminal.

Output: network request containing visual information, audio information, and metadata transmitted to server.

### Step 3:

Server receives, validates, and stores raw data.

Server terminates the network connection, verifies authentication tokens, checks file integrity and MIME types, and rejects malformed or unsupported content.

Server writes the visual and audio data to persistent storage and registers metadata in a database, associating data with a session ID and user ID.

Input: network request containing visual information, audio information, and metadata from terminal.

Output: stored visual and audio data records and a session entry in a database.

### Step 4:

Server performs image preprocessing and article detection.

Server loads visual information from storage, decodes images or frames, and applies an image processing module to resize, denoise, and normalize pixel values.

Server runs an object-detection neural network on the preprocessed frames to detect articles, compute bounding boxes, and assign preliminary type labels and confidence scores to each detection.

Input: stored visual information associated with a session ID.

Output: a set of detected article regions with bounding boxes, preliminary type labels, and confidence scores.

### Step 5:

Server extracts article features and estimates deterioration.

Server crops each detected article region from the original frames and feeds the cropped images into a feature-extraction neural network to compute feature vectors.

Server passes these feature vectors through a deterioration estimation head to compute a deterioration score or category, and then encapsulates all information into article records containing feature information, type information, placement position information, and deterioration information.

Input: detected article regions and preliminary labels from Step 4.

Output: structured article information records for each detected article.

### Step 6:

Server analyzes user behavior information and generates a user profile.

Server queries purchase history, viewing history, and owned-object tables associated with the user ID, and loads the retrieved records into a data-frame structure.

Server cleans and normalizes the records, computes statistics such as category frequency and price ranges, and applies a machine-learning model to derive preference scores, lifestyle indicators, and budget tendency metrics, which are stored in a user profile record.

Input: user behavior information retrieved from databases (purchase history, viewing history, owned-object information).

Output: user profile including preference information, lifestyle information, and budget tendency information.

### Step 7:

Server performs emotion analysis based on audio and visual cues.

Server retrieves audio information and, if available, facial image regions from the session data, and converts audio waveforms into feature representations such as spectrograms.

Server inputs the audio features and optional facial images into an emotion analysis unit that outputs emotion probabilities, then derives an emotion type and intensity score and stores them in an emotion record.

Input: stored audio information and optional facial regions associated with the session.

Output: emotion information including emotion type, intensity information, and associated confidence.

### Step 8:

Server constructs a context-specific prompt sentence for the generative AI model.

Server gathers article information, user profile information, and emotion information and inserts summarized values into predefined template segments.

Server selects and combines segments according to rules that consider the number and condition of articles, dominant user preferences, and the current emotional state, and concatenates them into a prompt sentence formulated as a natural-language instruction.

Input: article information records, user profile record, emotion record.

Output: a dynamically generated prompt sentence tailored to the current session.

### Step 9:

Server sends the prompt sentence to the generative AI model and parses the response.

Server transmits the constructed prompt sentence to a generative AI model through an interface module and specifies inference parameters such as maximum length and sampling strategy.

Server receives the generated text response, identifies sections corresponding to proposed products and explanations, and extracts product descriptions and suggested roles (replacement, additional, or new proposals).

Input: prompt sentence generated in Step 8.

Output: raw generative AI response text containing proposed product names, categories, and natural-language rationales.

### Step 10:

Server maps generated proposals to catalog entries and builds product candidate information.

Server converts each proposed product description into an embedding vector and performs similarity search against catalog product embeddings to identify matching or nearest products.

Server determines for each matched product whether it is a replacement product, an additional product, or a newly proposed product based on owned-object information and article deterioration scores, and assigns a relevance score using a scoring function over similarity, preference alignment, and novelty.

Input: generated text proposals from Step 9 and catalog database records.

Output: product candidate information including candidate identifiers, classification flags, and relevance scores.

### Step 11:

Server computes emotion-adaptive ranking and generates a product proposal list.

Server adjusts relevance scores by applying an emotion-dependent weighting function that increases or decreases the importance of certain product categories relative to the current emotional state.

Server sorts the candidate products by emotion-adjusted priority, optionally groups them into sections such as replacements and add-ons, and composes a structured product proposal list with ordering and explanatory text for transmission.

Input: product candidate information from Step 10 and emotion information from Step 7.

Output: ordered, emotion-adaptive product proposal list including candidate products and explanations.

### Step 12:

Server transmits the product proposal list to terminal.

Server packages the product proposal list into a response payload or a push notification message and invokes a notification service or communication application endpoint associated with terminal.

Server ensures that only the top-ranked subset of candidates and essential metadata are included to limit bandwidth usage.

Input: product proposal list generated in Step 11 and terminal addressing information.

Output: network message containing the product proposal list delivered to terminal.

### Step 13:

Terminal receives and displays the product proposal list.

Terminal decodes the received payload, extracts product identifiers, names, images, prices, explanations, and grouping information, and renders them in a graphical user interface as scrollable cards or lists.

Terminal enables interactive controls such as selection buttons, detail views, and purchase links so that user can explore the proposals.

Input: network message from server containing the product proposal list.

Output: visual display of proposed products and interactive UI elements on terminal.

### Step 14:

User interacts with the proposals and optionally performs purchases or evaluations.

User reviews the displayed products, taps items to view details, adds selected products to a shopping cart, completes purchases through linked commerce flows, or provides ratings and textual comments.

Terminal records each interaction event with time, product identifier, and action type.

Input: displayed product proposal list and UI controls.

Output: user interaction events representing selections, purchases, and evaluations.

### Step 15:

Terminal transmits feedback information to server.

Terminal aggregates interaction events, purchase confirmations, and user evaluations into a feedback payload and associates the payload with the original session ID and prompt identifier.

Terminal sends this payload to server over a secure network connection, using an event logging or feedback API.

Input: recorded interaction events, purchase information, and evaluation information.

Output: network request containing structured feedback information delivered to server.

### Step 16:

Server updates prompt construction rules and recommendation algorithms based on feedback.

Server stores received feedback information with references to the corresponding article information, user profile, emotion information, prompt sentence, and generative AI response.

Server periodically analyzes aggregated feedback to retrain ranking models, adjust weight parameters in emotion-adaptive scoring, and revise prompt templates and rule parameters, thereby modifying internal control logic for future sessions.

Input: feedback information linked to past sessions and internal model state.

Output: updated model parameters, revised prompt construction rules, and improved recommendation behavior for subsequent executions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

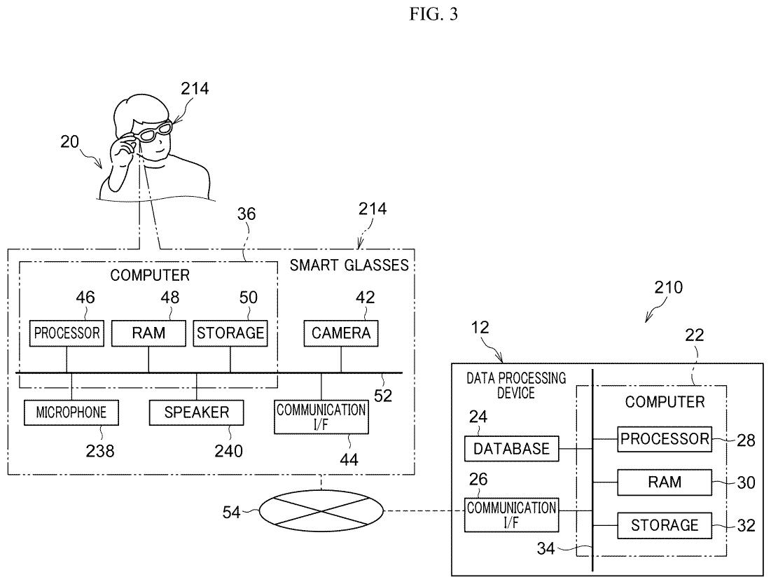

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

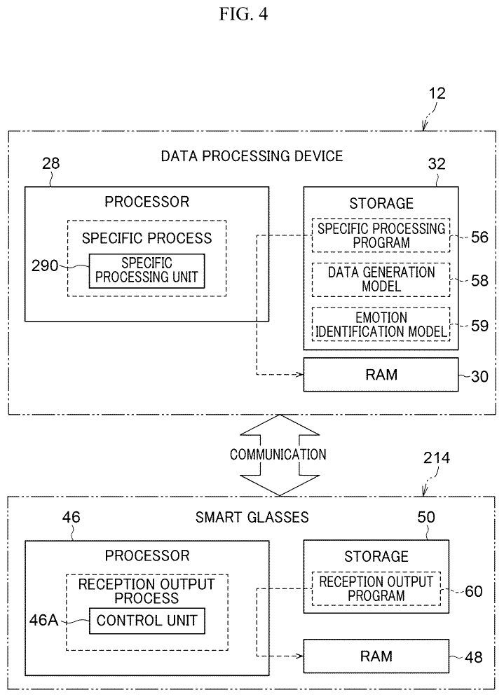

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

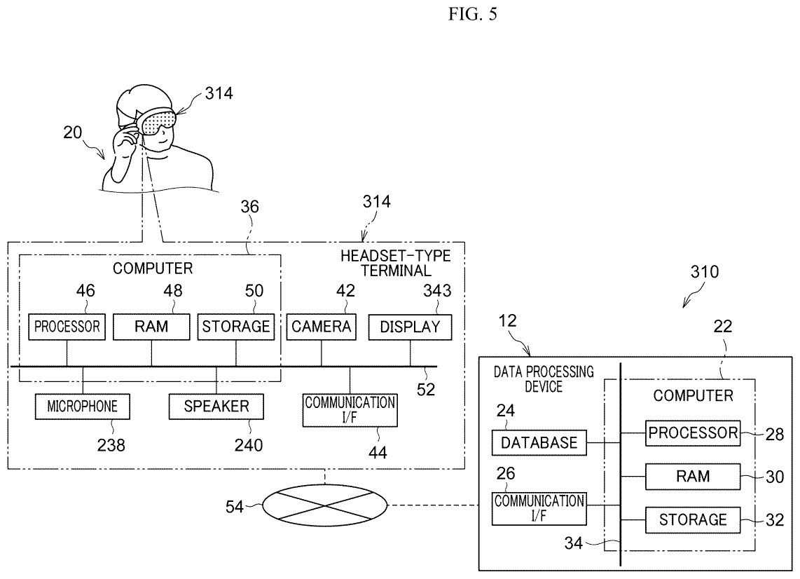

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

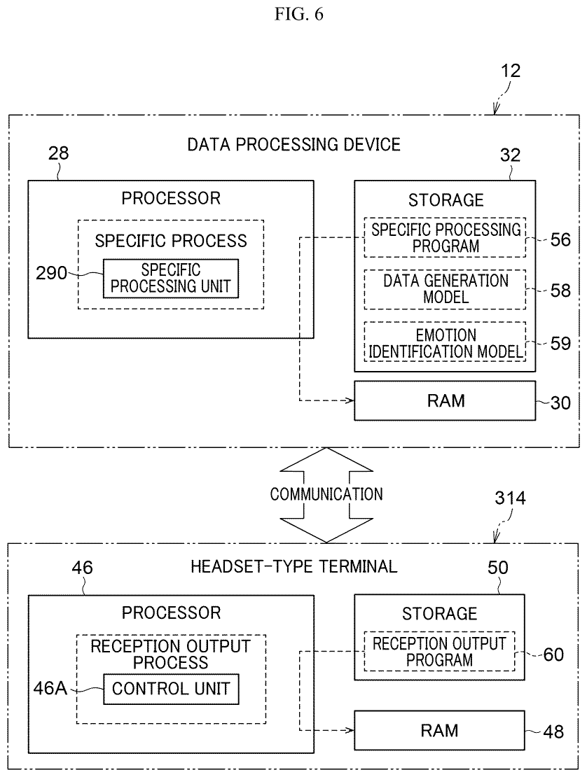

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

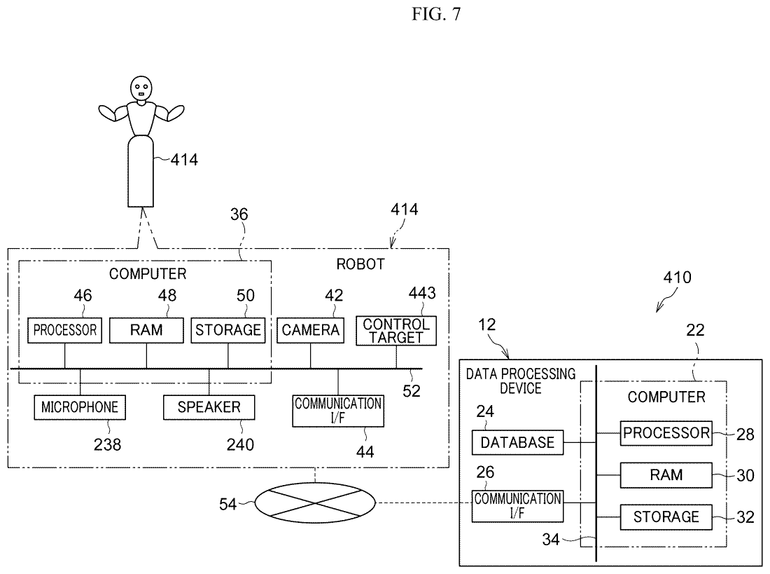

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

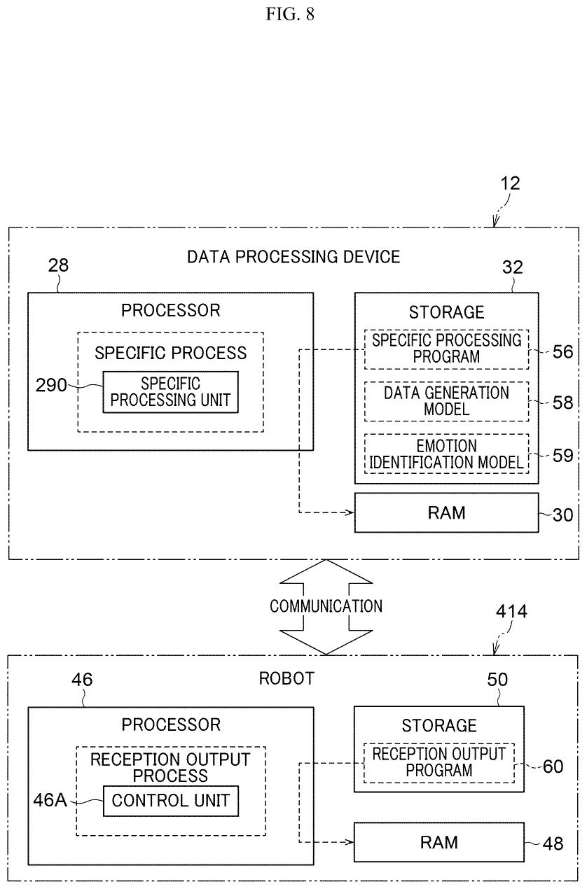

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

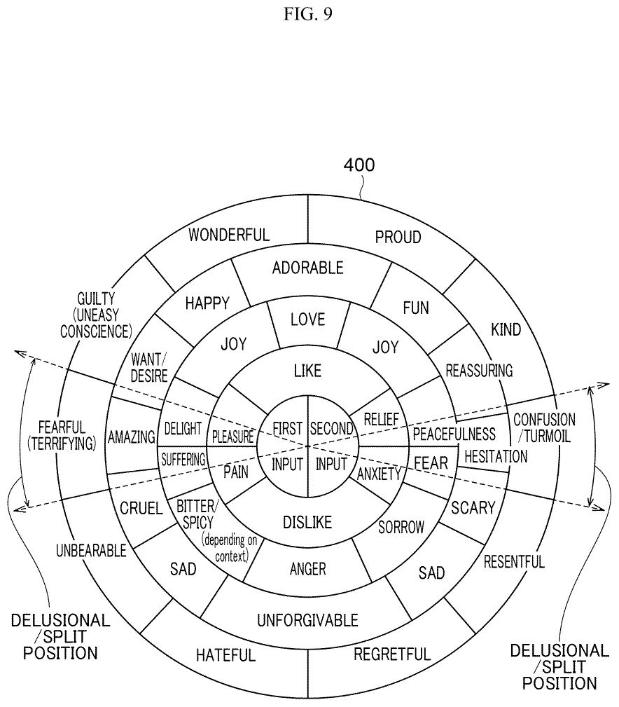

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

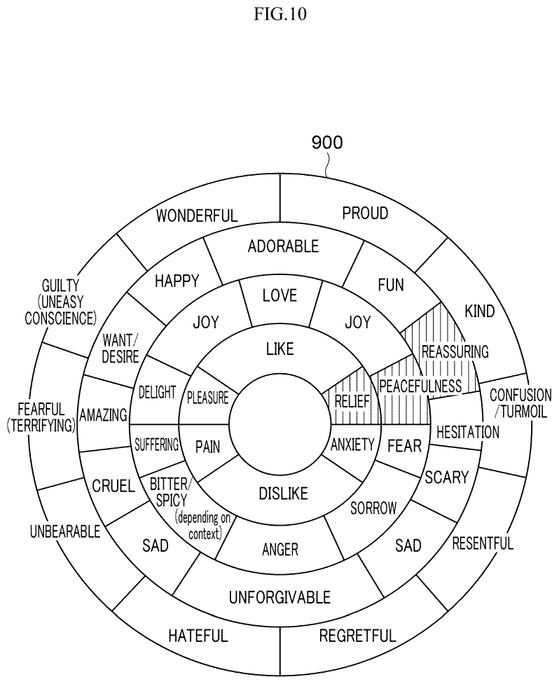

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a communication function, digital data comprising image information or video information of a space acquired by a user using an imaging function of an information processing terminal,
perform preprocessing on the digital data by using an image processing program, the preprocessing including at least a pixel count conversion process and a noise reduction process, and convert the digital data into a data format for analysis processing,
generate a prompt sentence including content that causes a generative AI model to extract product information, manufacturing information, and deterioration information from the preprocessed data, and input the prompt sentence into the generative AI model to cause the generative AI model to specify the product information, the manufacturing information, and the deterioration information,
reference user information storage that stores holding product information and purchase history information of the user, and based on the product information and the deterioration information specified by the generative AI model and the holding product information and the purchase history information, specify products not held by the user, generate a prompt sentence including content that causes the generative AI model to generate recommended product information reflecting an interest and a preference of the user, and input the prompt sentence into the generative AI model to obtain the recommended product information, generate response information including at least one of explanatory text and list information for the user, based on the recommended product information and the product information, the manufacturing information, and the deterioration information, and transmit the response information to the information processing terminal, and
compare the recommended product information and the product information with the holding product information of the user, and extract, by category or by use, a group of products not held by the user.

### Supplementary 2

The system according to supplementary 1,
wherein the processor is configured to
generate a prompt sentence including content that causes the generative AI model to calculate, based on the deterioration information and the holding product information of the user, an index indicating at least one of replacement priority and usability continuation, and to propose an alternative product or a complementary product according to the index, and input the prompt sentence into the generative AI model to obtain the recommended product information.

### Supplementary 3

The system according to supplementary 1,
wherein the processor is configured to
generate a prompt sentence including content that causes the generative AI model to extract cooperative products that, when used in combination with products held by the user, are expected to improve at least one of functionality and convenience, based on products not held by the user that are specified by the generative AI model, and input the prompt sentence into the generative AI model to obtain the recommended product information including the cooperative products.

### Application Example 1

### Supplementary 1

A system comprising a processor,
wherein the processor is configured to
receive, via a communication network, digital information including image information or video information acquired by a user using an image acquisition device or a video acquisition device, and perform preprocessing including pixel count conversion, frame extraction, and image quality correction on the digital information for analysis,
generate a prompt sentence describing analysis contents for specifying product attribute information, manufacturing date information, and degradation state information, input the prompt sentence together with the preprocessed image information or video information to a generative AI model, acquire product information data including the product attribute information, the manufacturing date information, and the degradation state information from the generative AI model, and store the acquired product information data in a storage device, execute inventory analysis based on the stored product information data by identifying a group of products owned by the user and extracting products not included in the group of products and missing products in categories of the group of products,
generate a prompt sentence describing analysis conditions and an output format for causing the generative AI model to generate recommendation candidates including products not owned by the user, high-performance alternative products, and complementary products that are beneficial to use in combination with the owned products, input the prompt sentence and the product information data to the generative AI model, and acquire recommendation candidate information from the generative AI model,
associate the acquired recommendation candidate information with merchandise management information, generate a merchandise proposal message for the user, and transmit the merchandise proposal message via a communication application to a terminal device having a display device,
receive, from the terminal device, store product information including products placed in a store, the store product information being acquired by the terminal device scanning the products using an imaging function for reading or a code reading function for identification, and the store product information being transmitted from the terminal device in real time, generate a prompt sentence describing analysis contents for specifying an in-store inventory state and a degradation state of in-store products based on the store product information and inventory management information, input the prompt sentence and the store product information to the generative AI model, and acquire in-store merchandise proposal information for proposing optimal products to visitors from the generative AI model.

### Supplementary 2

The system according to supplementary 1,
wherein the processor is configured to
extract, based on the degradation state information and deadline information included in the stored product information data, owned products that satisfy predetermined conditions regarding a degree of degradation or proximity to an expiration time, generate a prompt sentence describing analysis contents for causing the generative AI model to propose replacement products and products having price advantages using an extraction result as input information, input the prompt sentence to the generative AI model, and acquire proposal information of new products from the generative AI model.

### Supplementary 3

The system according to supplementary 1,
wherein the processor is configured to
generate ownership state information including category information, usage purpose information, and usage environment information of the group of products owned by the user, generate a prompt sentence describing analysis contents for causing the generative AI model to propose complementary products that are functionally or practically related to the group of products and improve convenience when used simultaneously, and high-performance products that improve performance of an overall system configuration, input the prompt sentence to the generative AI model, and acquire proposal information of the complementary products and the high-performance products from the generative AI model.

### Example 2

### Supplementary 1

A system comprising a processor,
wherein the processor is configured to
acquire, using identification information associated with a user, usage history information and ownership information of the user stored in an information storage device, and
generate, on the basis of the usage history information and the ownership information, an analysis result including at least a usage period of owned objects, objects that are candidates for replacement, and objects that are not owned but become useful when used in combination with existing owned objects, and generate a prompt sentence in a natural language format for input to a generative AI model by formatting the analysis result into natural language, and input the prompt sentence into the generative AI model, obtain a natural language output regarding proposals of candidate objects based on the analysis result, and analyze the natural language output to extract a proposal object set including at least high-performance and highly up-to-date objects, objects not owned by the user, and objects whose usefulness is improved when used in combination with existing owned objects, and
generate proposal information for each proposal object included in the proposal object set by adding proposal reason information and acquisition information, and transmit the proposal information to a terminal via a communication control interface of a communication application.

### Supplementary 2

The system according to supplementary 1,
wherein the processor is configured to
include, in the prompt sentence to be input to the generative AI model, information regarding the usage period and degradation state of the owned objects so as to cause the generative AI model to propose replacement candidate objects in accordance with the degradation state.

### Supplementary 3

The system according to supplementary 1,
wherein the processor is configured to
include, in the prompt sentence to be input to the generative AI model, information regarding types of objects not owned by the user and condition information relating to combined use with the owned objects so as to cause the generative AI model to propose unowned objects that are beneficial when used in combination with the owned objects.

### Application Example 2

### Supplementary 1

A system comprising a processor,
wherein the processor is configured to
receive visual information and audio information acquired by a user using an information processing terminal having an imaging function, perform preprocessing on the visual information by using an image processing unit, determine presence or absence of an article in the visual information, and extract article information including feature information, type information, and placement position information for each article,
obtain the extracted article information and user behavior information including past purchase history information, viewing history information, and owned-object information, analyze the user behavior information by using a statistical processing unit and a machine learning unit, and generate a user profile including preference information, lifestyle information, and budget tendency information,
estimate an emotional state of the user by using an emotion analysis unit based on the audio information or text information and the visual information, and generate emotion information including an emotion type and intensity information representing the emotional state, dynamically construct a prompt sentence, which is an instruction sentence to be input to a generative AI model, based on the article information, the user profile, and the emotion information, input the prompt sentence to the generative AI model, and cause the generative AI model to specify product information, manufacturing information, and deterioration information corresponding to the articles included in the visual information,
generate product candidate information by identifying, based on a response from the generative AI model, products not owned by the user, classifying the products not owned into replacement products, additional products, and newly proposed products based on the article information and the user profile, and assigning relevance information to each product,
generate an emotion-adaptive product proposal list by determining a presentation order and presentation priority of the product candidates based on the product candidate information and the emotion information so as to amplify or alleviate the emotional state of the user, transmit the product proposal list to the information processing terminal via a notification service or a communication application, and cause the information processing terminal to display the product proposal list, and
accumulate feedback information including user selection operation information, purchase information, and evaluation information acquired from the information processing terminal, and, based on the feedback information, update rules for constructing the prompt sentence and a recommendation algorithm cooperating with the generative AI model so as to improve accuracy of subsequent product proposals.

### Supplementary 2

The system according to supplementary 1,
wherein the processor is configured to
use deterioration information included in the extracted article information and the user profile to identify an article having a high update priority, input to the generative AI model a prompt sentence instructing preferential proposal of a replacement product according to the update priority, and, based on a response from the generative AI model, place the replacement product at a high rank in the product proposal list.

### Supplementary 3

The system according to supplementary 1,
wherein the processor is configured to
specify a composition of owned objects of the user based on the extracted article information, extract as gap information a function or category absent in the composition of the owned objects, input to the generative AI model a prompt sentence instructing proposal of products to be used in combination with the owned objects and products of a new category based on the gap information and the user profile, and, based on a response from the generative AI model, include the combination products and the new-category products in the product proposal list.

What is claimed is:

1. A system comprising:
circuitry configured to:
receive, via a communication interface coupled to a packet-switched network, image data from a terminal device;
perform preprocessing on the image data to generate analysis-ready data;
generate a first prompt sentence for instructing a generative neural network model to extract attribute information from the analysis-ready data, and input the first prompt sentence into the generative neural network model to acquire the attribute information;
generate a second prompt sentence for instructing the generative neural network model to identify inference results based on the attribute information and context data, and input the second prompt sentence into the generative neural network model to acquire the inference results; and
transmit output data based on the inference results to the terminal device via the communication interface.

2. The system according to claim 1, wherein the preprocessing comprises performing object detection on the image data using a trained detection model to identify bounding box regions within the image data, and cropping the image data according to the bounding box regions to generate a plurality of region tensors.

3. The system according to claim 2, wherein the circuitry is further configured to perform optical character recognition on each region tensor to extract text strings, and associate the extracted text strings with the corresponding bounding box regions as part of the attribute information.

4. The system according to claim 3, wherein the circuitry is further configured to extract visual feature vectors from each region tensor using a convolutional neural network, and classify each region tensor into a category based on the visual feature vectors and the extracted text strings.

5. The system according to claim 4, wherein the attribute information comprises, for each classified region, at least a category label, a specification parameter derived from the visual feature vectors, and a date parameter derived from the extracted text strings.

6. The system according to claim 1, wherein the circuitry is further configured to compute a condition score for each item of the attribute information by analyzing visual features of the analysis-ready data corresponding to the item, the condition score representing a degree of degradation or wear.

7. The system according to claim 6, wherein the circuitry is further configured to access a user profile storage device to retrieve ownership records associated with an identifier of the terminal device, and compare the attribute information with the ownership records to identify items present in the image data but absent from the ownership records.

8. The system according to claim 7, wherein the circuitry is further configured to compute a replacement priority index for each item in the ownership records based on the condition score and an age parameter derived from the attribute information, and incorporate the replacement priority index into the second prompt sentence.

9. The system according to claim 1, wherein the circuitry is further configured to generate a third prompt sentence for instructing the generative neural network model to identify complementary items that, when used in combination with items corresponding to the attribute information, are expected to improve functionality, and input the third prompt sentence into the generative neural network model to acquire complementary item data.

10. The system according to claim 9, wherein the output data comprises a structured list including the inference results and the complementary item data, and wherein each entry in the structured list includes connection information comprising a network address for accessing a detail resource.

11. The system according to claim 1, wherein the context data comprises at least one of behavior history information retrieved from a log repository associated with the terminal device and preference information derived from past interaction records.

12. The system according to claim 11, wherein the circuitry is further configured to perform emotion analysis on text data or audio data received from the terminal device using an emotion identification model to determine an emotion state, and incorporate the emotion state into the second prompt sentence.

13. The system according to claim 12, wherein the circuitry is further configured to adjust a presentation order of the inference results based on the emotion state so as to prioritize inference results aligned with the determined emotion state.

14. The system according to claim 1, wherein the image data comprises video data, and wherein the preprocessing further comprises sampling frames from the video data at a configured temporal interval and batching the sampled frames as a plurality of image tensors for input to the generative neural network model.

15. The system according to claim 1, wherein the circuitry is further configured to enrich the attribute information by querying a catalog storage device using category labels and specification parameters extracted from the analysis-ready data, and incorporating catalog records into the first prompt sentence as supplementary context.

16. The system according to claim 15, wherein the attribute information extracted by the generative neural network model comprises product information including a brand identifier, a model identifier, a manufacturing date, and a deterioration state for each item detected in the image data.

17. The system according to claim 1, wherein the circuitry is further configured to log interaction events received from the terminal device including selection data and feedback data in a log repository, and update a prompt template used to construct the first prompt sentence or the second prompt sentence based on the logged interaction events.

18. A system comprising:
circuitry configured to:
receive, via a communication interface coupled to a packet-switched network, image data from a terminal device;
perform object detection on the image data using a trained detection model to identify bounding box regions, and extract visual feature vectors from each bounding box region using a convolutional neural network;
perform optical character recognition on each bounding box region to extract text strings;
generate a first prompt sentence based on the visual feature vectors and the extracted text strings, the first prompt sentence instructing a transformer-based generative neural network model to extract attribute information including a category label, a specification parameter, and a condition score for each bounding box region;
input the first prompt sentence into the transformer-based generative neural network model and acquire the attribute information;
compare the attribute information with ownership records retrieved from a user profile storage device to identify gaps in ownership;
generate a second prompt sentence based on the attribute information and the identified gaps, the second prompt sentence instructing the transformer-based generative neural network model to generate inference results comprising suggested items corresponding to the identified gaps; and
transmit output data comprising the inference results to the terminal device via the communication interface.

19. The system according to claim 18, wherein the circuitry is further configured to compute a replacement priority index for each item in the ownership records based on the condition score and an age parameter, and incorporate the replacement priority index into the second prompt sentence to cause the transformer-based generative neural network model to prioritize the inference results according to the replacement priority index.

20. A method performed by circuitry of a server coupled to a packet-switched network via a communication interface, the method comprising:
receiving, via the communication interface, image data from a terminal device;
performing preprocessing on the image data to generate analysis-ready data;
generating a first prompt sentence for instructing a generative neural network model to extract attribute information from the analysis-ready data, and inputting the first prompt sentence into the generative neural network model to acquire the attribute information;
generating a second prompt sentence for instructing the generative neural network model to identify inference results based on the attribute information and context data, and inputting the second prompt sentence into the generative neural network model to acquire the inference results; and
transmitting output data based on the inference results to the terminal device via the communication interface.
